(19) United States
(12) Patent Application Publication
(10) Pub. No.: US 2008/0208859 A1
(43) Pub. Date: Aug. 28, 2008

(54) Method and system for generating an organizational display of entity relationships

(75) Inventors: Bret Alan Cohen, Zurich (CH); Tomer Lanis, Bremgarten (CH); Deborah Jane Slaughter, Singapore (SG); Joseph M. Valazquez, West Orange, NJ (US)

Correspondence Address: KING & SPALDING;CREDIT SUISSE SECURITIES (USA) LLC, 1180 PEACHTREE STREET, NE, 34TH FLOOR, ATLANTA, GA, 30309-3521, US

(73) Assignee: Credit Suisse Securities (USA) LLC, New York, NY (US)

(21) Appl. No.: 11/980,197

(22) Filed: Oct. 29, 2007

Related U.S. Application Data
(60) Provisional application No. 60/855,728, filed on Oct. 30, 2006.

(51) Int. Cl. G06F 17/30; G06F 7/00; G06Q 99/00

(52) U.S. Cl. 707/7; 707/102; 707/5; 705/7; 707/E17.047

(57) ABSTRACT

An enterprise database system generates organizational and consolidation organizational charts for an entity. Organizational charts are generated by accepting one or more ownership thresholds, including: voting percentage, equity ownership, and the number of board members under entity control. The system also accepts inclusion thresholds used to determine which entities will be selected from a database. The database is evaluated based on the ownership thresholds and inclusion thresholds to identify one or more organizational entities that satisfy the given thresholds. An entity is selected and the voting interests for the parent entities of that entity are evaluated. One parent entity is identified as the primary parent entity. The system presents the primary parent entity in the organizational chart. Any additional parent entities are listed alphabetically separate from the primary parent entity. Child entities are also determined by the system and listed below the primary parent entity in the organizational chart.

### STATEMENT OF RELATED PATENT APPLICATION

This non-provisional patent application claims priority under 35 U.S.C. § 119 to U.S. Provisional Patent Application No. 60/855,728, titled Method and System for Generating Approvals and Documentation for Entities and Transactions and for Generating Current and Historical Reporting Related Thereto, filed Oct. 28, 2006. This provisional application is hereby fully incorporated herein by reference.

### FIELD OF THE INVENTION

The present invention relates to the field of financial entity creation approval and reporting. In particular, the invention provides a system and methods for providing for and requesting a series of threshold parameters and generating an organizational chart and/or consolidated organizational chart for entities based on the threshold parameters.

### BACKGROUND OF THE INVENTION

Prior to new company entities, special purpose entities (“SPE's” and/or “financial entities”), and transactions being formed or entered into or company entities being acquired by a financial institution, these entities/transactions (hereinafter collectively “entities”) must go through an approval process. The approval process generally requires that several different individuals or groups in financial, accounting, legal, tax, treasury, and operational divisions of the institution evaluate the new or acquired entity based on their particular area of expertise to determine if certain standards or thresholds are met or policies are followed. The number of parties that must approve an entity can be numerous and the information that each approver needs to complete their evaluation of an entity can be wide-ranging. Conventional approval systems did a poor job of tracking the status of an approval for an entity once the approval request was generated. This meant that the person sponsoring the new entity for approval had to track down each approver to determine where they were in the approval process.

The conventional entity approval systems also did not automatically provide the individualized information that each approver needed to complete their analysis, or did not provide it in a format geared to the needs of that particular approver. This meant that the approver would typically have to manually transfer information from one system to another to complete their approval review. Furthermore, conventional systems generally did a poor job of pointing out a situation where an entity approval was rejected by one or more of the approvers. This resulted in approvers who completed their analysis subsequent to the rejection continuing their approval review, even though it was not necessary.

Once the entity is approved, the sponsor for the entity or another needs to notify the system that the entity was formed or acquired. Once either formed or acquired (or the transaction entered into), information relating to the entity is manually entered into in a database for future needs. These needs potentially include subsequent evaluation of the entity based on new or updated information and accumulation of information for accounting analysis, and financial, corporate, and regulatory reporting. Conventional systems for storing the historical entity information are separate from the approval system. The separation of the approval system from the historical tracking system for an entity makes it difficult to track the life cycle of an entity from its inception to its termination. Once an entity is approved, information developed or stored during the approval process must be manually transferred to the historical database if the institution wishes to use that information. Furthermore, information from the approval process and the historical information of the entity is typically needed when completing an audit. By having the approval system and the historical database system separate from each other, it increases the risk that information needed for an audit, financial, corporate, or regulatory report will be overlooked or not presented to the auditor or may unintentionally be omitted from financial, corporate, or regulatory reports.

In view of the foregoing, there is a need in the art for a method and system for generating approval documentation and monitoring the approval process of a newly formed or acquired company entity, special purpose entity, transaction or entity that is going to be acquired. Furthermore, there is a need in the art for a method and system for storing company entity and SPE related information in one or more databases and generating corporate, regulatory, accounting, and financial reporting documentation related to the company entity or SPE. In addition, there is a need in the art for a method of searching for and viewing historical information related to a company entity or an SPE. Furthermore, there is a need in the art for a single system capable of capturing and tracking information about both company entities and SPE's.

There is also a need in the art for a system and methods for generating legal structure organizational charts and/or consolidation organizational charts for company entities and SPE's. Furthermore, there is a need in the art for a system and method for generating requests to certify accounting information related to a company entity or SPE and receiving and storing the responses to the certification request in a historical database. In addition, there is a need in the art for a system and methods for evaluating data related to an SPE or company entity for changes that signify a need to review an entity's status and generating a request to review the entity's status based on the change to determine if the status of the company entity or SPE has changed or the accounting evaluation for the entity is different based on the change in the data.

### SUMMARY OF THE INVENTION

The inventive system can provide efficiencies and improvements over conventional methods by automating the generation of organizational charts and consolidated organization charts. For one aspect of the present invention, the system can generate an organizational chart for an organizational entity by accepting one or more ownership thresholds. The ownership thresholds can include a voting percentage in an entity, an equity ownership percentage in an entity, and the number of board members under the control of the organization. The system can also accept one or more inclusion thresholds. Each inclusion threshold can be used to determine which entities will be selected from a database in the system.

The database is evaluated based on the ownership thresholds and inclusion thresholds to identify one or more organizational entities that satisfy the given thresholds. One of the organizational entities identified from the database is selected and the voting interests for the parent entities of that organizational entity are evaluated. One of the parent entities is identified as the primary parent entity for the organizational entity. The primary parent entity can be identified based on the amount of voting interest each parent entity has in the organizational entity. The parent entity with the highest voting interest being designated as the primary parent. The primary parent entity can then be presented in the organizational chart for the organizational entity. The remaining parent entities can be listed in the organizational chart separate from the primary parent entity. In one example, the remaining parent entities are listed in alphabetical order.

For another aspect of the present invention, the system can accept an identifier associated with an organizational entity. The identifier can be the name of the organizational entity or an entity identification number. The system can accept one or more filter parameters for evaluating a database to determine if any of the entities in the database are a child entity for the organizational entity. The database can be evaluated using the filtering parameters. Those entities satisfying the filtering parameters can be displayed as child entities of the organizational entity.

From the following detailed description of the exemplary embodiments, as read in conjunction with, and in reference to, the accompanying figures, the above aspects, objects and features of the present invention, along with others, will become apparent to one of ordinary skill in the art.

### BRIEF DESCRIPTION OF THE DRAWINGS

For a more complete understanding of the exemplary embodiments of the present invention and the advantages thereof, reference is now made to the following description in conjunction with the accompanying drawings in which:

FIG. 1 is a block diagram illustrating an exemplary operating environment for implementation of various embodiments of the present invention;

FIG. 2 is a flowchart illustrating the general steps of a process for: generating approvals and documentation related to forming or acquiring an entity or to initiating a transaction involving an entity; storing entity or transaction information in a historical database for retrieval, analysis and report generating; generating current and historical reports related an entity or transaction, such as general corporate, regulatory and financial reporting documentation; and modifying entity or transaction information in the historical database in accordance with an exemplary embodiment of the present invention;

FIG. 3 is a flowchart illustrating in greater detail, the general steps of a process for generating approvals and documentation related to forming or acquiring an entity or to initiating a transaction involving an entity in accordance with one exemplary embodiment of the present invention;

FIG. 4 is a flowchart illustrating an exemplary process for generating a datasheet and receiving information relating to the creation or acquisition of a special purpose entity or the initiation of a transaction involving an entity in accordance with the exemplary process of FIG. 2;

FIGS. 5 and 5A are flowcharts illustrating a process for generating approvals related to forming or acquiring an entity or to initiating a transaction involving an entity in accordance with one exemplary embodiment of the present invention;

FIG. 6 is a flowchart illustrating a process for assigning a group of approvers for the exemplary approval process of FIGS. 5 and 5A in accordance with one exemplary embodiment of the present invention;

FIGS. 7 and 7A are flowcharts illustrating a process for generating status information for entities or transactions involving entities in the process of approval formation or acquisition in accordance with one exemplary embodiment of the present invention;

FIGS. 7B and 7C are exemplary illustrations of screenshots of an approval status user interface as presented by the system in accordance with one exemplary embodiment of the present invention;

FIG. 8 is a flowchart illustrating a process for conducting a special purpose entity validation or validation of a transaction involving an entity in accordance with one exemplary embodiment of the present invention;

FIG. 8A is a flowchart illustrating a process for conducting a company entity validation in accordance with one exemplary embodiment of the present invention;

FIG. 9 is a flowchart illustrating a process for generating a certification request for an entity or transaction involving an entity and receiving a response to the request in accordance with one exemplary embodiment of the present invention;

FIG. 10 is a flowchart illustrating a process for generating an ownership organizational chart report based on entity or transaction information in accordance with one exemplary embodiment of the present invention;

FIGS. 10A-C are exemplary illustrations of screenshots of an organizational chart creation user interface and an organizational chart as presented by the system in accordance with one exemplary embodiment of the present invention;

FIG. 11 is a flowchart illustrating a process for generating a consolidation organization chart and report based on entity or transaction information in accordance with one exemplary embodiment of the present invention;

FIGS. 11A-F are exemplary illustrations of screenshots of a consolidated organizational chart creation user interface and a consolidated organizational chart as presented by the system in accordance with one exemplary embodiment of the present invention;

FIG. 12 is a flowchart illustrating a process for generating ad-hoc reports based on entity or transaction information in accordance with one exemplary embodiment of the present invention;

FIG. 12A is an exemplary illustration of a screenshot of a quick search reporting menu user interface as presented by the system in accordance with one exemplary embodiment of the present invention;

FIG. 12B is an exemplary illustration of a screenshot of the ad-hoc reporting menu user interface as presented by the system in accordance with one exemplary embodiment of the present invention;

FIG. 13 is a flowchart illustrating a process for generating disclosure reports for formed or acquired entities or transactions involving entities in accordance with one exemplary embodiment of the present invention;

FIGS. 13A through 13E are exemplary illustrations showing different aspects of the reassessment process as performed by the system in accordance with one exemplary embodiment of the present invention;

FIG. 14 is a flowchart illustrating a process for adding an entity to a reassessment report, adding it to a disclosure report, or excluding it from a disclosure report, based on an exemplary embodiment;

FIG. 15 is a flowchart illustrating a process for performing a reassessment of entities in accordance with an exemplary embodiment of the present invention;

FIG. 16 is a flowchart illustrating a process for completing a correction to one or more data fields in the historical record database in accordance with one exemplary embodiment of the present invention;

FIG. 16A is an exemplary illustration of a screenshot of a change details display for a correction in the historical database as presented by the system in accordance with one exemplary embodiment of the present invention;

FIG. 17 is a flowchart illustrating a process for completing an update to one or more data fields in the historical record database in accordance with one exemplary embodiment of the present invention;

FIG. 17A is an exemplary illustration of a screenshot of a change details display for an update in the historical database as presented by the system in accordance with one exemplary embodiment of the present invention;

FIG. 18 is a flowchart illustrating a process for moving the edit or insertion date of data in a data field in the historical record database to a time prior to the edit date currently referenced in accordance with one exemplary embodiment of the present invention;

FIG. 18A is an exemplary illustration of a screenshot of a change details display for a move in the historical database as presented by the system in accordance with one exemplary embodiment of the present invention; and

FIG. 19 is an exemplary illustration of a display of consolidated and non-consolidated parents and children of an entity as presented by the system in accordance with one exemplary embodiment of the present invention.

### DETAILED DESCRIPTION OF THE EXEMPLARY EMBODIMENTS

The present invention includes computer-implemented methods and systems for: generating approvals and documentation related to forming or acquiring an entity or to initiating a transaction involving an entity; storing entity or transaction information in a historical database for retrieval, analysis and report generating; generating current and historical reports related an entity or transaction, such as general corporate, regulatory and financial reporting documentation; and modifying entity or transaction information in the historical database. The present invention further includes various interactive displays and notification tools to implement or facilitate the foregoing methods and systems.

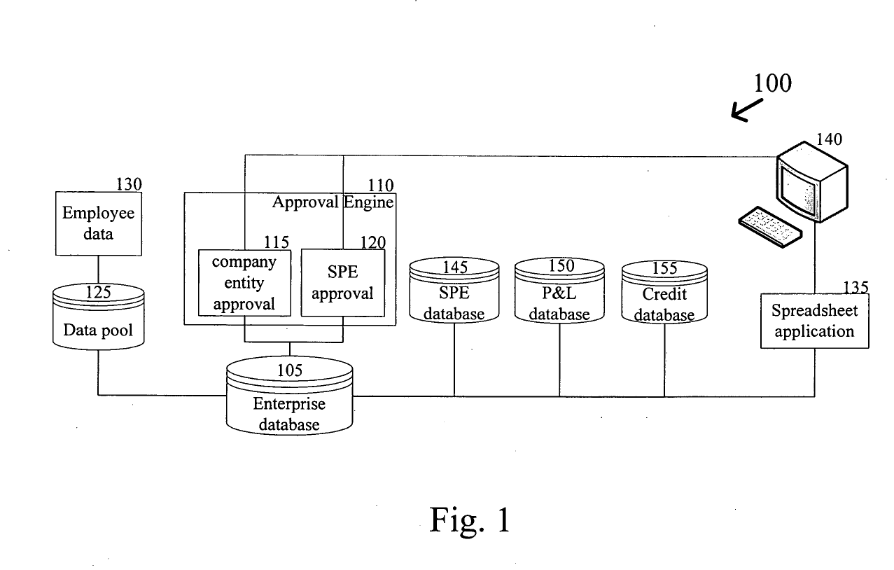

Referring now to the drawings in which like numerals represent like elements throughout the several figures, aspects of the present invention and an exemplary operating environment will be described in the context of FIGS. 1-18A. FIG. 1 is a block diagram illustrating an exemplary operating system 100 for implementation of various embodiments of the present invention. Those skilled in the art will appreciate that FIG. 1 and the associated discussion are intended to provide a brief, general description of one exemplary embodiment of computer hardware and program modules, and that additional information is readily available in appropriate programming manuals, user's guides and similar publications.

The exemplary operating system 100 includes an enterprise database 105. The enterprise database 105 includes one or more information storage mediums from which information is retrieved and inserted into an approval engine 110 for completing an approval process for a company entity or an SPE. In one exemplary embodiment, the enterprise database 105 includes a portion of the company entity related information and all special purpose entity (“SPE”) information, including approval records, certification records and other financial and accounting information related to SPE's. The system 100 also includes an approval engine 110 communicably attached via a distributed computer network to the enterprise database 105 and a personal computer 140. The approval engine includes a company entity approval program 115 and an SPE approval program 120.

The system 100 also includes a data pool database 125 that is communicably attached via a distributed computer network to the enterprise database 105. In one exemplary embodiment, the data pool database 125 accesses employee data 130 and provides that employee data 130 to the enterprise database 105 for us in an approval process. The system 100 includes an SPE database 145 that is communicably attached via a distributed computer network to the enterprise database 105. In one exemplary embodiment, the SPE database 145 provides information including, but not limited to, net asset value per unit for products, bid prices for products, and information about issuers and products for SPE's. The system 100 also includes the profit and loss (“P&L”) database 150, which is communicably attached via a distributed computer network to the enterprise database 105. The P&L database 150 provides financial information related to company entities, SPE's and products to the enterprise database 105. The system 100 further includes the credit database 155. The credit database 155 is communicably attached via a distributed computer network to the enterprise database 105.

The system 100 further includes a general purpose computing device that can be in the form of a conventional personal computer 140. As shown in FIG. 1, the personal computer 140 is capable of operating in the networked environment and can be communicably attached via a distributed computer network to the enterprise database 105, an approval engine 110, an SPE database 145, a profit and loss database 150 and a credit database 155. In one exemplary embodiment, the personal computer 140 is capable of executing a spreadsheet application 135 and displaying a user interface for the spreadsheet application on the personal computer 140. In one exemplary embodiment, the spreadsheet application 135 is the EXCEL spreadsheet application software offered by Microsoft Corporation. The spreadsheet application 135 can reside either at the personal computer 140 or at a remote location, such as a remote server (Not Shown).

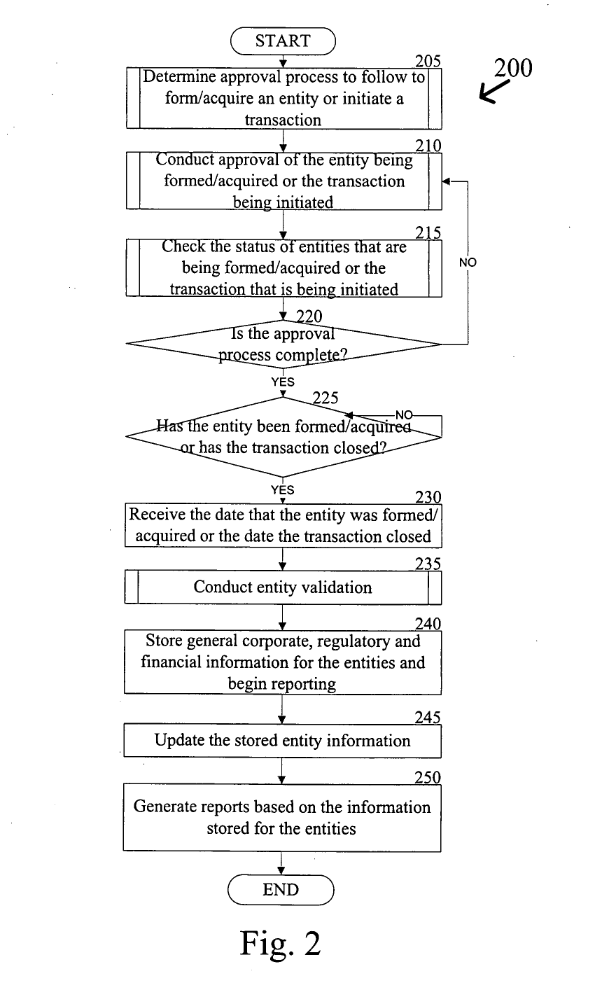

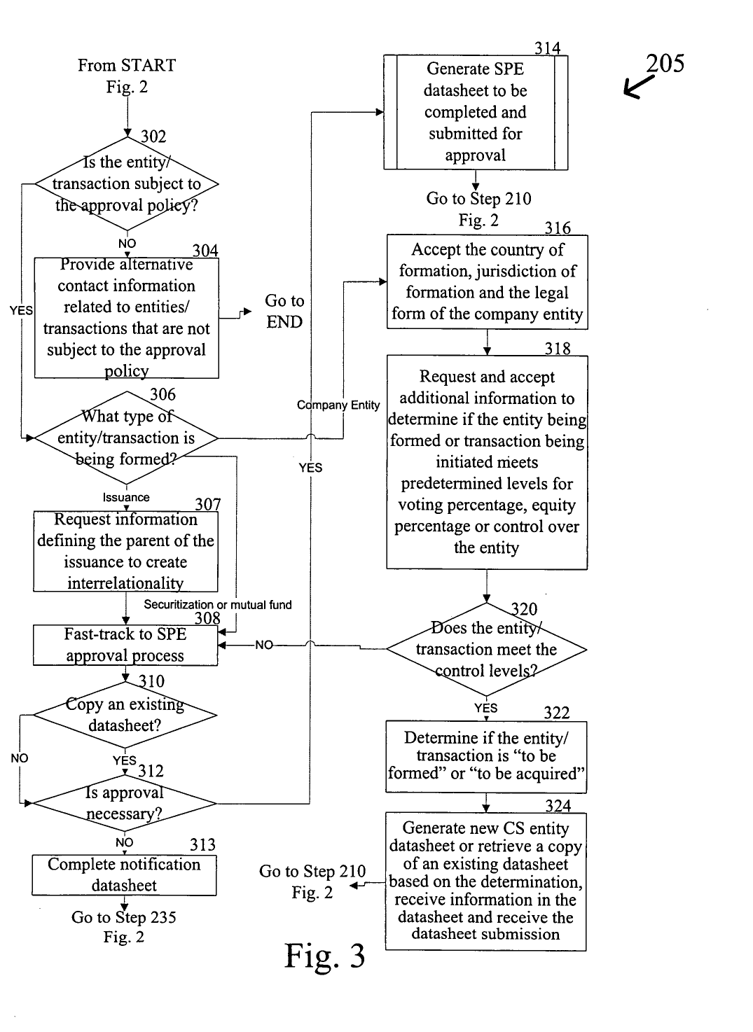

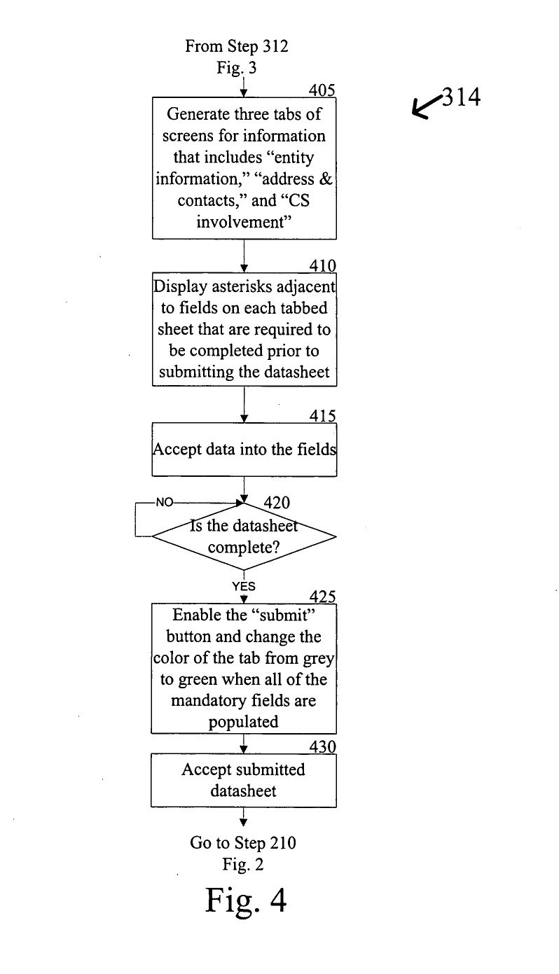

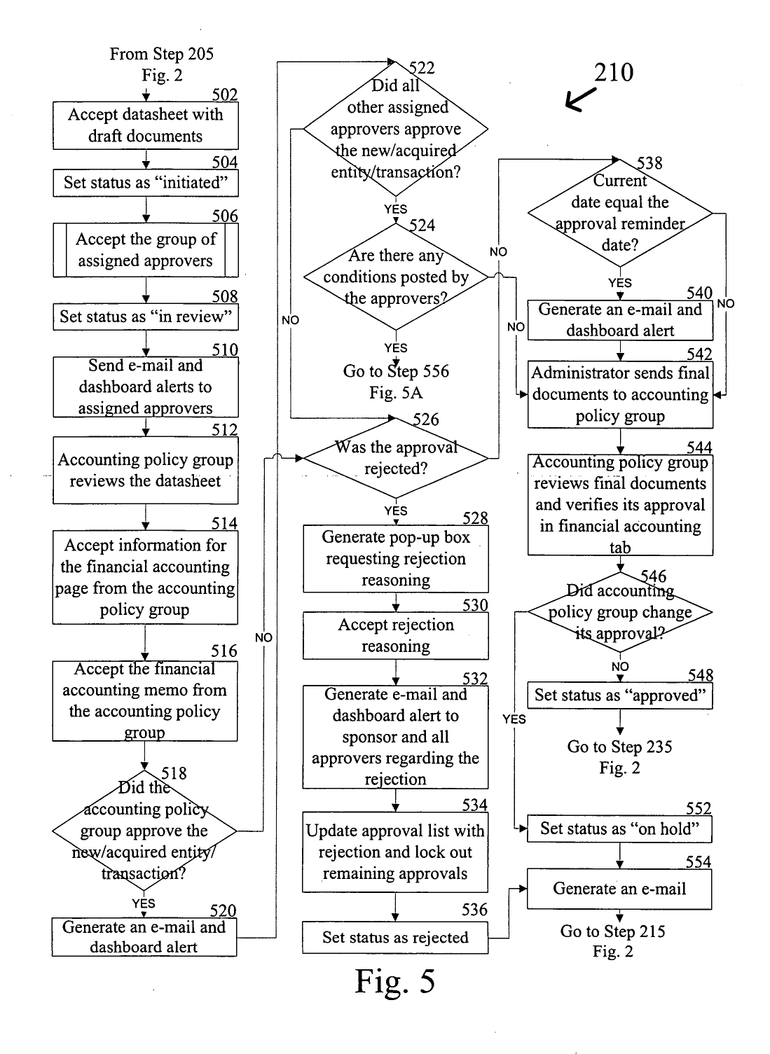

FIGS. 2-18A are logical flowchart diagrams and screenshots of user interface displays illustrating computer-implemented methods for: generating approvals and documentation related to forming or acquiring an entity or to initiating a transaction involving an entity; storing entity or transaction information in a historical database 105 for retrieval, analysis and report generating; generating current and historical reports related an entity or transaction, such as general corporate, regulatory and financial reporting documentation; and modifying entity or transaction information in the historical database 105. FIGS. 2-18A further illustrate various interactive displays and notification tools to implement or facilitate the foregoing methods and systems. While the historical database 105 includes historical information about SPE entities, company entities and transactions, it should be understood that the historical database 105 also includes current information about SPE entities, company entities and transactions and the use of the phrase “historical database” throughout the specification is not meant to limit the type or scope of information contained in the database, but rather to emphasize that information can be stored, maintained, modified, and reported not only for a specific point in time but for, and over, a period of time of unlimited duration, from the past to the present; therefore the term “historical” references the ability to create a history of an entity over the lifetime of the entity, and store this history, in the enterprise database 105.

FIG. 2 is a logical flowchart diagram presented to illustrate the general steps of an exemplary process 200 for: generating approvals and documentation related to forming or acquiring an entity or to initiating a transaction involving an entity; storing entity or transaction information in a historical database 105 for retrieval, analysis and report generating; generating current and historical reports related an entity or transaction, such as general corporate, regulatory and financial reporting documentation; and modifying entity or transaction information in the historical database 105 within the operating environment of the present invention. Now referring to FIG. 2, the exemplary method 200 begins at the START step and proceeds to step 205, in which a determination is made by the system 100, based on certain pre-set parameters, as to which approval process to follow in order to form or acquire an entity or initiate a transaction. In one exemplary embodiment, the approval processes that may be followed include, but are not limited to, special purpose entity (“SPE”) or transaction approvals or company entity approvals. In step 210, the approval process is conducted for the entity being formed or acquired or the transaction being initiated. The status of the entities that are being formed or acquired or the transactions that are being initiated may be monitored by viewing a digital dashboard in step 215.

In step 220, an inquiry is conducted to determine if the approval process has been completed. If the approval process has not been completed, the “NO” branch is followed to step 210. On the other hand, if the approval process has been completed, the “YES” branch is followed to step 225. In step 225, an inquiry is conducted to determine if the entity has been formed or acquired or if the transaction has been closed. If the entity has not been formed or acquired or the transaction has not been closed, the “NO” branch is followed back to the beginning of step 225 to await formation or acquisition of the entity or the closure of the transaction. On the other hand, if the entity has been formed or acquired or the transaction has been closed, the “YES” branch is followed to step 230, where the date that the entity was formed or acquired or the date that the transaction was closed is accepted by the system 100 from a user.

Entity or transaction validation is completed in step 235. In one exemplary embodiment, the validation can be different for SPE's and company entities or transactions to be initiated. In step 240, general corporate, regulatory and financial information for the entities and transactions is stored in the enterprise database 105 and the system 100 begins report generation for that entity or transaction. In step 245, the entity and/or transaction information that is stored in the historical database 105 can be updated (i.e. modified to correct, update, or move the stored information). In step 250, reports can be generated based on the entity or transaction information stored in the historical database 105. The process continues from step 250 to the END step.

FIG. 3 is a logical flowchart diagram illustrating an exemplary computer-implemented method for generating approvals and documentation related to forming or acquiring an entity or to initiating a transaction involving an entity as completed by step 205 of FIG. 2. Referring now to FIGS. 2 and 3, the exemplary method 205 begins with an inquiry to determine if the entity or transaction is subject to the approval policy in step 302. In one exemplary embodiment, a determination of whether an entity or transaction is subject to the approval policy can take the form of the questions and potential responses. Example of questions related to company entities and SPE's include: the type of company entity or SPE; the country of jurisdiction of formation; the jurisdiction of formation; the legal form in the jurisdiction of formation; the global legal form; if a subsidiary owns 20% or more of the voting stock in this entity on an undiluted basis; if a subsidiary owns 25% or more of the total equity of this entity; if a subsidiary control the majority of the board of directors/managers or have other control rights. If the entity or transaction is not subject to the approval policy, the “NO” branch is followed to step 304, where alternative contact information related to entities or transactions that are not subject to the approval policy is displayed. The process then continues from step 304 to the END step. Returning to step 302, if the entity or transaction is subject to the approval policy, the “YES” branch is followed to step 306.

In step 306, an inquiry is conducted to determine the type of entity or transaction being formed. In one exemplary embodiment, the types of entities or transactions include, but are not limited to, company entities, issuances, securitizations and mutual funds. If the entity or transaction being formed is an issuance, the “Issuance” branch is followed to step 307, where the system 100 requests and receives from the user information defining the parent of the issuance so that the system 100 can form an interrelationality between the parent and the issuance. The process then continues from step 307 to step 308.

Returning to step 306, if the entity or transaction being formed is a securitization or mutual fund, the “Securitization or mutual fund” tab is followed to step 308, where the entity or transaction is fast-tracked to the SPE approval process. In step 310, an inquiry is conducted to determine if the user copies an existing datasheet that has been stored in the system 100. In one exemplary embodiment, the user may select from the database 105 a datasheet that has been previously completed in order to reduce the amount of time it may take the user to complete the datasheet. If the user copies an existing datasheet, the “YES” branch is followed to step 312. Otherwise, the user does not copy an existing datasheet and the “NO” branch is followed to step 312.

In step 312, an inquiry is conducted to determine if approval is necessary. For certain entities or transactions, the datasheet may need to be completed for tracking and report generation purposes based on the information contained therein, but the entity or transaction itself may not be required to go through the approval process. If approval is not necessary, the “NO” branch is followed to step 313, where a notification datasheet is generated and completed by a user for the entity or transaction. The process then continues from step 313 to step 235 of FIG. 2. If approval is necessary, the “YES” branch is followed to step 314, where the system 100 generates the SPE datasheet to be completed and submitted for approval. In one exemplary embodiment, the SPE datasheet may include tabs of worksheets that request information including but not limited to, addresses & contacts, qualifications/registrations, board & officers, ownership and capitalization, company involvement/approval, financial accounting, regulatory, and product description. The process continues from step 314 to step 405 of FIG. 4.

Returning to step 306, if the type of entity or transaction being formed or acquired is a company entity, the “Company entity” branch is followed to step 316, where the system 100 accepts the country of formation, jurisdiction of formation and the legal form of the company entity. In step 318, the system 100 requests and accepts additional information from the user to determine if the entity or transaction being formed meets predetermined levels for voting percentage, equity percentage, or control over the entity. In one exemplary embodiment the predetermined level for voting percentage is twenty percent of total voting on an undiluted basis. In another exemplary embodiment, the predetermined level for equity percentage is twenty-five percent of total equity. If the entity or transaction meets the predetermined levels for voting percentage, equity percentage, or control over the entity, the entity or transaction will typically be categorized as a company entity. In step 320, an inquiry is conducted to determine if the entity or transaction meets the control levels. If the entity or transaction does not meet the control levels, the “NO” branch is followed to step 308. Otherwise, if the entity or transaction meets the control levels, the “YES” branch is followed to step 322 to determine if the entity or transaction is “to be formed” or “to be acquired.” In one exemplary embodiment, several different types of company entity datasheets are available for generation and submission based on whether the company entity is “to be formed” or “to be acquired” and/or based on the global legal form for the entity. In step 324, the system 100 generates a new company entity datasheet based on whether the entity is “to be formed” or “to be acquired.” The system 100 receives information in the generated datasheet and receives the request to submit the datasheet. The process then continues from step 324 to step 210 of FIG. 2.

FIG. 4 is a logical flowchart diagram illustrating an exemplary computer-implemented method for generating a datasheet and receiving information relating to the creation or acquisition of a special purpose entity or the initiation of a transaction involving an entity as completed by step 314 of FIG. 3. While FIG. 4 describes an exemplary process for generating a datasheet for SPE entity or transaction approval, the process for generating a datasheet for company entity approval, as discussed in step 324 of FIG. 3, operates similarly but may have a somewhat different look and feel. Referring now to FIGS. 2, 3, and 4, the exemplary method 314 begins at step 405, where the system 100 generates three tabs of worksheets or screens requesting information that includes “entity information,” “address & contacts,” and “company involvement”. Those of ordinary skill in the art will understand that the selected tabs of information request screens may be modified to include more or less information or may be displayed in a different order and would still be within the teachings of this invention. In one exemplary embodiment, the company entity datasheet includes additional tabs of screens requesting additional information. In step 410, asterisks are displayed adjacent to the fields on each tabbed sheet that are required to be completed prior to submitting the datasheet.

In step 415, data is accepted into the data fields of the tabbed screens. In step 420, an inquiry is conducted to determine if the datasheet is complete. In one exemplary embodiment, the SPE datasheets are completed or populated by front office personnel. In this exemplary embodiment, datasheet completion is based on whether all of asterisked required fields have been populated. If the datasheet is not complete, the “NO” branch is followed back to step 420. Otherwise, the “YES” branch is followed to step 425, where the “submit” button is enabled and the color of the tab changes from grey to green when all of the required fields have been populated. In step 430, the system 100 accepts the submitted datasheet. The process continues from step 430 to step 210 of FIG. 2.

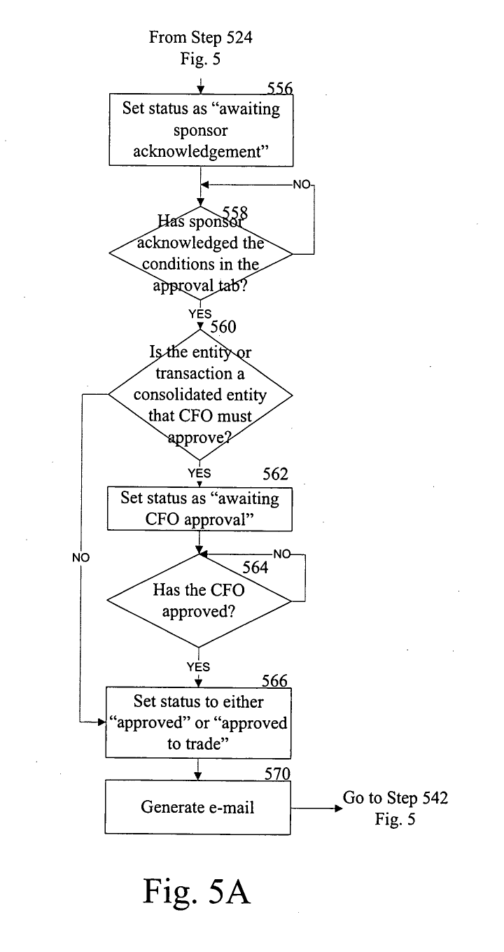

FIGS. 5 and 5A are logical flowchart diagrams illustrating an exemplary computer-implemented method for generating approvals related to forming or acquiring an entity or to initiating a transaction involving an entity as completed by step 210 of FIG. 2. Referring now to FIGS. 2, 5, and 5A, the exemplary method 210 begins with the system 100 accepting the datasheet and draft documents related to the creation or acquisition of an entity or the initiation of a transaction in step 502. In step 504, the status for the current entity or transaction is designated as “initiated.” In one exemplary embodiment, the statuses for entities or transaction are automatically generated by the system 100 based on the current stage of the entity or transaction in the approval process. The system 100 accepts a group of assigned approvers in step 506. In one exemplary embodiment, an administrator assigns the approvers. In step 508, the system 100 changes the status of the entity or transaction such that the status for the current entity or transaction is designated as “in review.”

In step 510, the system 100 generates an e-mail and dashboard alerts to the assigned approvers. The accounting policy group reviews the datasheet for the entity or transaction in step 512. In step 514, information related to the financial accounting page is accepted. In one exemplary embodiment, the accounting policy group provides the information for the financial accounting page. A financial accounting memo is accepted into the datasheet application in step 516. In one exemplary embodiment, the financial accounting memo is generated by the accounting policy group.

In step 518, an inquiry is conducted to determine if the accounting policy group approves the new/acquired entity or transaction. If the accounting policy group does not approve the new/acquired entity or transaction, the “NO” branch is followed to step 526. Otherwise, the “YES” branch is followed to step 520, where the system 100 generates an e-mail and dashboard alert. In step 522, an inquiry is conducted to determine if all of the other remaining assigned approvers approved the new/acquired entity or transaction. If the remaining approvers did not approve the new/acquired entity or transaction, the “NO” branch is followed to step 526. On the other hand, if the remaining approvers did approve the new/acquired entity or transaction, the “YES” branch is followed to step 524. In step 524, an inquiry is conducted to determine if there are any conditions to the approvals posted by the approvers. In one exemplary embodiment, an approver may place one or more conditions on the approver's approval of the entity or transaction that must be met before actual approval is granted by the approver. If there are conditions to the approval, the “YES” branch is followed to step 556 of FIG. 5A. Otherwise, the “NO” branch is followed to step 542. Returning to step 522, if the approvers did not approve the entity or transaction, the “NO” branch is followed to step 526.

In step 526, an inquiry is conducted to determine if the approval of the new or acquired entity or transaction was rejected by one or more persons in the approval group. If the approval was not rejected, the “NO” branch is followed to step 538. Otherwise, the “YES” branch is followed to step 528, where the system 100 generates a pop-up box requesting the reason for the rejection. In one exemplary embodiment, the approver who rejects the approval of the entity or transaction will provide information related to why they decided to reject it. In step 530, the system 100 accepts the reasoning for the rejection. The system 100 generates an e-mail and dashboard alert to the sponsor and all approvers regarding the fact that one of the approvers rejected the entity or transaction in step 532. In step 534, the approval list is updated with the rejection of one of the approvers and the remaining approvals are locked out so that no additional approvals or rejections may be accepted. In step 536, the system 100 changes the status of the entity or transaction such that the status is designated as “rejected.” The process continues from step 536 to step 554.

In step 538, an inquiry is conducted to determine if the current date is equal to the approval reminder date. In one exemplary embodiment, the approval reminder date is a date provided by the administrator that assigns the approvers and is a date such that, if an approver has not approved or rejected an entity or transaction by the approval reminder date, that particular approver will be sent a reminder e-mail message that an approval is necessary within a short period of time. If the current date is equal to the approval reminder date for the current entity or transaction, the “YES” branch is followed to step 540, where the system 100 generates an e-mail and dashboard alert for all approvers who have not yet approved or rejected the entity or transaction. On the other hand, if the date is not equal to the approval reminder date, the “NO” branch is followed to step 542.

In step 542, the administrator sends the final documents to the accounting policy group. The accounting policy group reviews the final documents and verifies its prior approval in the financial accounting tab in step 544. In step 546, an inquiry is conducted to determine if the accounting policy group has changed its approval. If the accounting policy group has not changed is approval, the “NO” branch is followed to step 548, where the system 100 changes the status of the entity or transaction such that the status is designated as “approved.” The process continues from step 548 to step 235 of FIG. 2. If the accounting policy group did change its approval, the “YES” branch is followed to step 552, where the system 100 changes the status of the entity or transaction such that the status is designated as “on hold.” In step 554, an email is generated to the sponsor and all approvers notifying them of the new status. The process continues from step 554 to step 215 of FIG. 2.

Returning to the “YES” branch originating in step 524 of FIG. 5, in step 556 of FIG. 5A, the system 100 changes the status of the entity or transaction such that the status is designated as “awaiting sponsor acknowledgement.” In step 558, an inquiry is conducted to determine if the sponsor has acknowledged the conditions in the approval tab. In one exemplary embodiment, acknowledgement of the conditions by the sponsor of the entity or transaction evidences that the sponsor agrees that the conditions will be met. If the sponsor has not acknowledged the conditions at this time, the “NO” branch is followed to step 558. On the other hand, if the sponsor has acknowledged the conditions, the “YES” branch is followed to step 560.

In step 560, an inquiry is conducted to determine if the SPE or transaction is a consolidated entity that the chief financial officer or other executive must approve. If the SPE or transaction is not a consolidated entity, the “NO” branch is followed to step 566. If the entity or transaction is a consolidated entity that must be approved by the CFO or other executive, the “YES” branch is followed to step 562, where the system 100 changes the status of the entity or transaction such that the status is designated as “awaiting CFO approval.” In step 564, an inquiry is conducted to determine if the CFO or other executive has approved the entity or transaction. If not, the “NO” branch is followed to step 564 to await CFO approval. Otherwise, the “YES” branch is followed to step 566, where the system 100 changes the status of the entity such that the status for the current entity is designated as “approved” or “approved to trade.” In step 570, the system 100 generates an e-mail. The process then continues from step 570 of FIG. 5A to step 542 of FIG. 5.

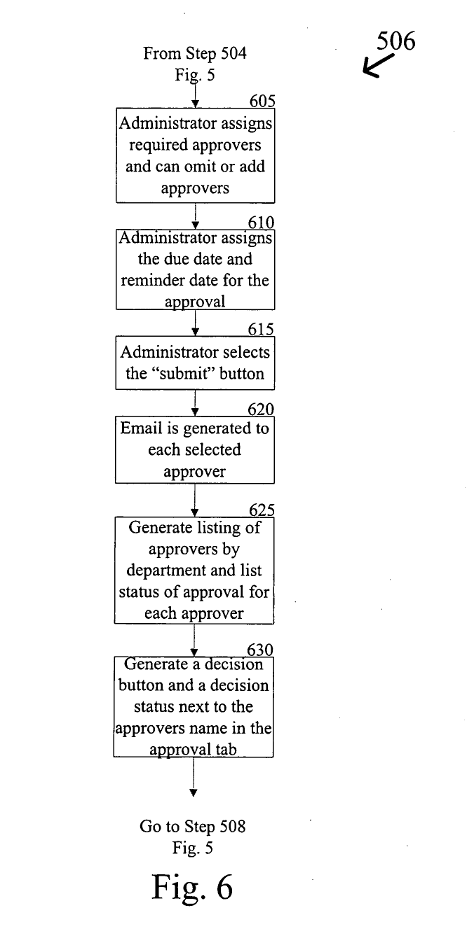

FIG. 6 is a logical flowchart diagram illustrating an exemplary computer-implemented method for assigning a group of approvers to an SPE entity or transaction approval process as completed by step 506 of FIG. 5. While the exemplary flowchart of FIG. 6 represents the steps for completing the approval process for an SPE entity or transaction, it should be understood that a similar process is conducted for company entities, however, the company entity approval process may have fewer or additional steps and those steps may be different from the process described in FIG. 6. Referring now to FIGS. 2, 5, and 6, the exemplary method 506 begins with the administrator assigning required approvers and adding or omitting approvers as needed in step 605. In one exemplary embodiment, for SPE approvals, transaction support (or another department, as may be designated from time to time) is the administrator and for company entity approvals, the corporate secretary (or another department, as may be designated from time to time) is the administrator. In step 610, the administrator assigns the due date and reminder dates for the approval. In step 615, the administrator selects the “submit” button.

An email is generated and transmitted to each selected approver in step 620. In step 625, the system 100 generates a listing of approvers by department and lists the status of approval for each approver. In step 630, the system 100 generates a decision button and decision status next to each approvers name in the approval tab. The process continues from step 630 to step 508 of FIG. 5.

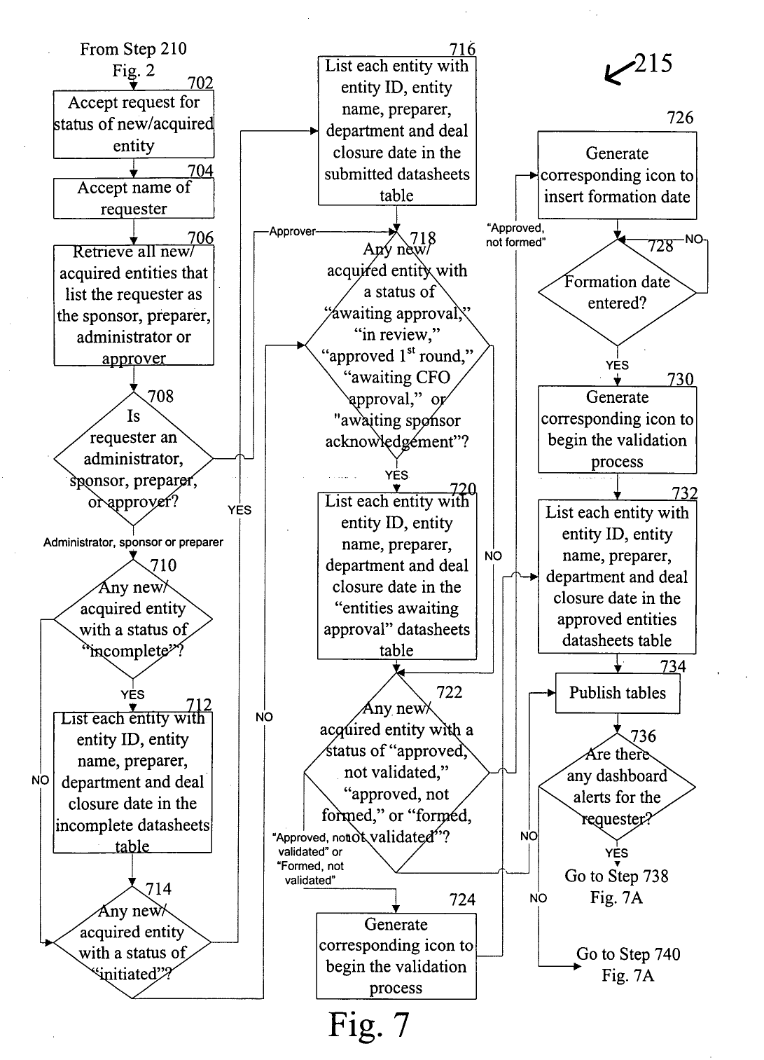

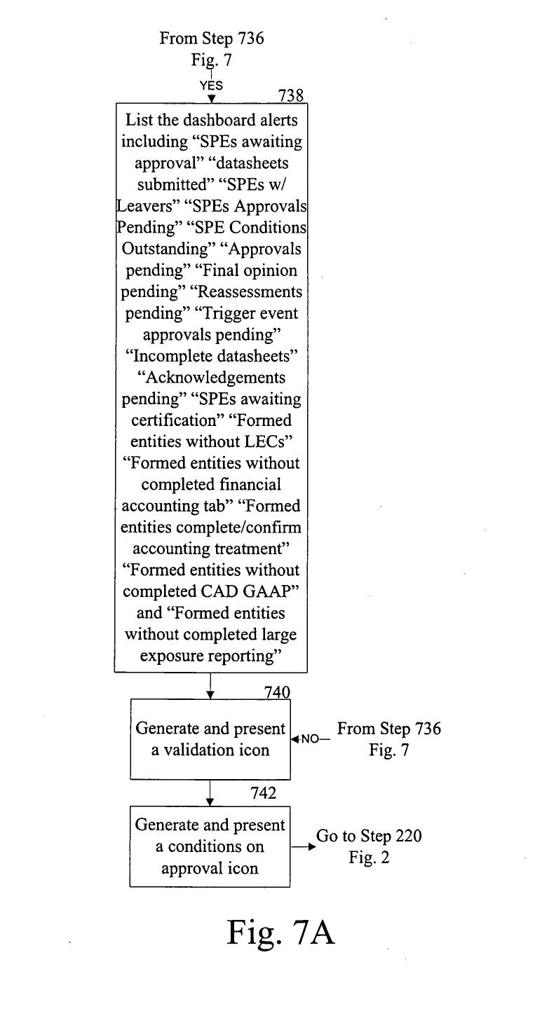

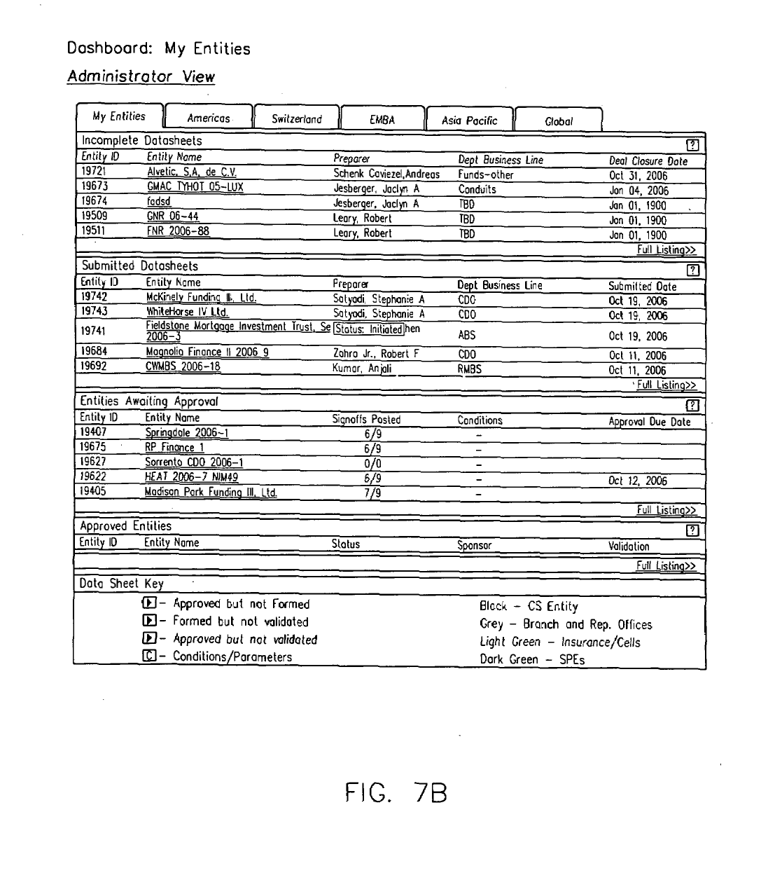

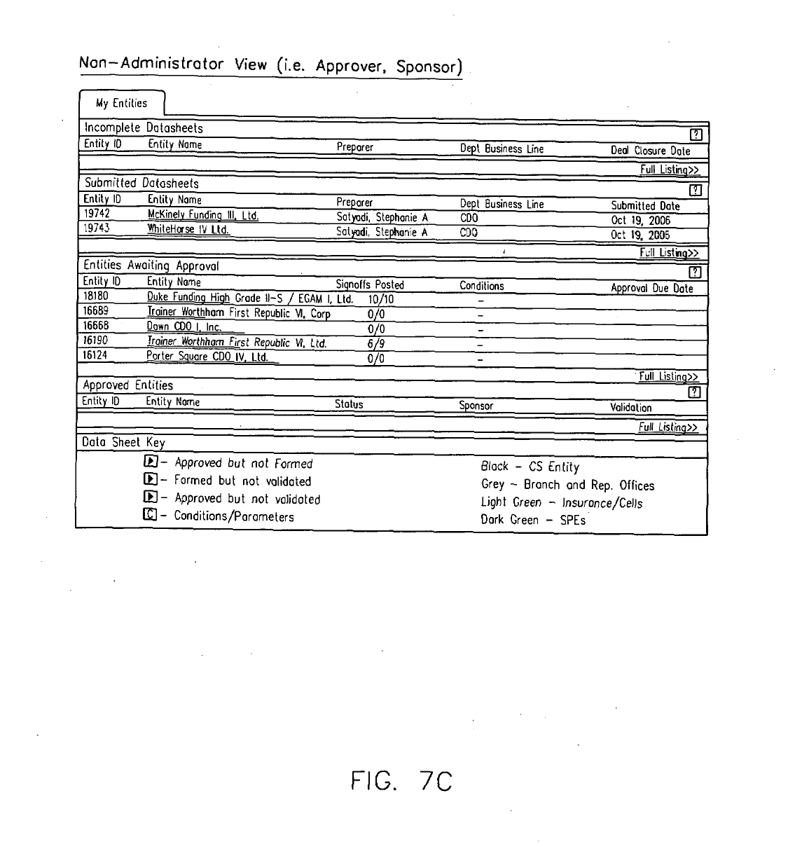

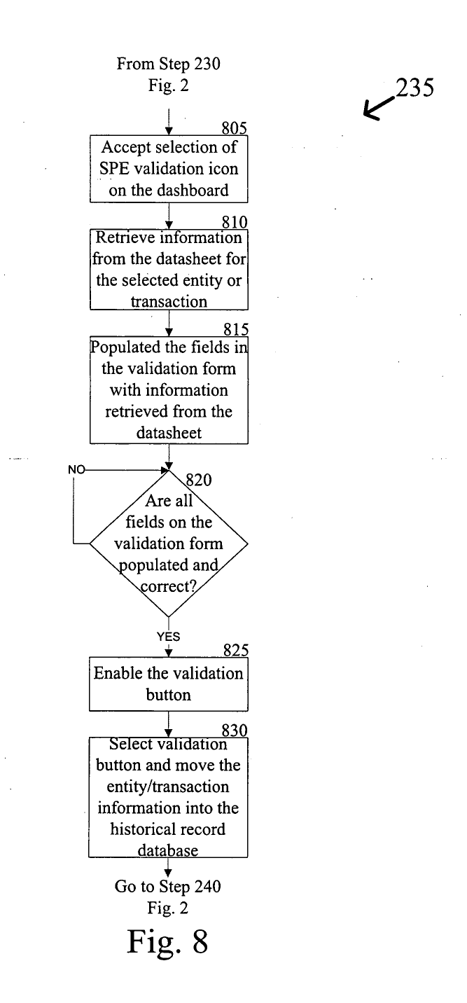

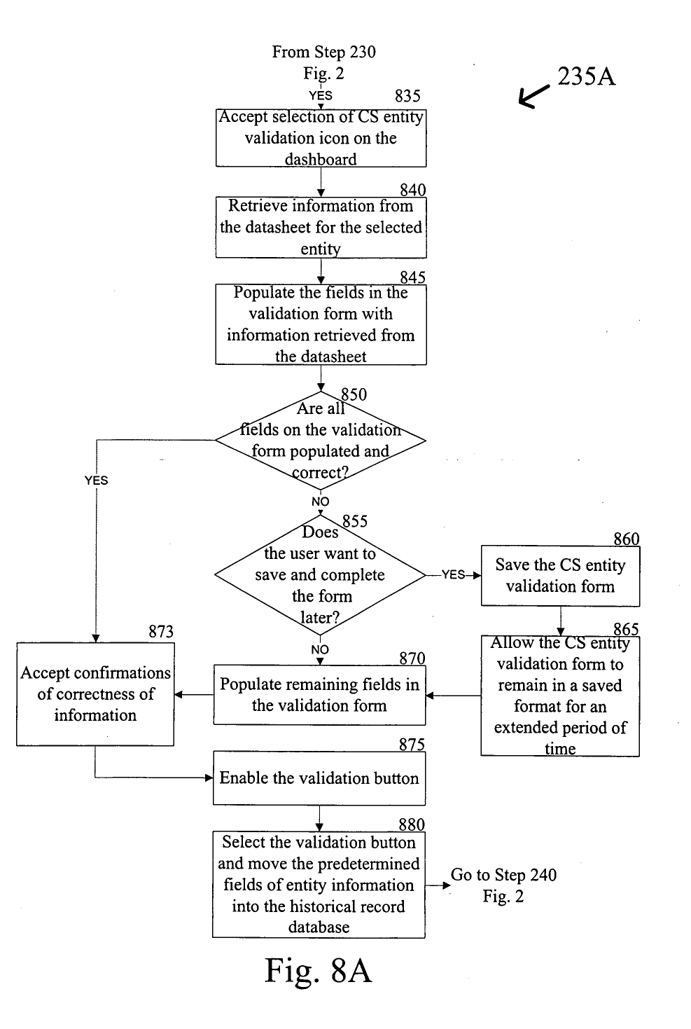

FIGS. 7 and 7A are logical flowchart diagrams illustrating an exemplary computer-implemented method for generating status information for entities or transactions involving entities in the process of formation or acquisition as completed by step 215 of FIG. 2. Referring now to FIGS. 2 and 7, the exemplary method 215 begins with the system 100 accepting a request for the status of a new/acquired entity in step 702. In one exemplary embodiment, the information provided in the status for an administrator is presented in the form of a digital dashboard as shown in the screenshot of FIG. 7B. Furthermore, in this exemplary embodiment, the information provided in the status for an approver or sponsor is presented in the form of a digital dashboard displayed on a user interface as shown in the screenshot of FIG. 7C. In step 704, the name of the requester is accepted. The system 100 retrieves all new or acquired entities that list their requester as a sponsor, preparer, administrator, or approver in step 706.

In step 708, an inquiry is conducted to determine if the requester of the status is an administrator, sponsor, preparer, or approver. In one exemplary embodiment, the requester is capable of qualifying as more than one of the positions above. If the requester is an administrator, sponsor, or preparer, the “Administrator, sponsor or preparer” branch is followed to step 710. On the other hand, if the requester is an approver, the “Approver” branch is followed to step 718. In step 710, an inquiry is conducted to determine if there are any new or acquired entities with the status of “incomplete” within the group of new or acquired entities that were retrieved for the particular requester. If there are new or acquired entities with the status of “incomplete,” the “YES” branch is followed to step 712, where the system 100 lists each new or acquired entity with the entity ID, entity name, preparer, department, and deal closure date in an “Incomplete” datasheet table. A copy of the “Incomplete” datasheet table is provided FIG. 7B. On the other hand, if there are no new or acquired entities with the status of “incomplete,” then the “NO” branch is followed to step 714.

In step 714, an inquiry is conducted to determine if there are any new or acquired entities with the status of “initiated.” If there are new or acquired entities with the status of “initiated” in the list that was retrieved in step 706, the “YES” branch is followed to step 716, where the system 100 lists each entity with its entity ID, entity name, preparer, department, and deal closure date in the “Submitted” datasheet table. A copy of the “Submitted” datasheet table is provided in FIG. 7B. On the other hand, if there are no new or acquired entities with the status of “initiated,” then the “NO” branch is followed to step 718. In step 718, an inquiry is conducted to determine if there are any new or acquired entities with a status of “awaiting approval,” “in review,” “approved 1^{st} round,” “awaiting CFO approval,” or “awaiting sponsor acknowledgement” in the list of entities retrieved in step 706. If there are new or acquired entities with those statuses, the “YES” branch is followed to step 720, where the system 100 lists each entity with its entity ID, entity name, preparer, department, and deal closure date in an “Entities awaiting approval” datasheet table. A copy of the “Entities awaiting approval” datasheet table is provided in FIG. 7B. On the other hand, if there are no new or acquired entities with those statuses, then the “NO” branch is followed to step 722.

In step 722, an inquiry is conducted to determine if there are any new or acquired entities with the status of “approved, not validated,” “approved, not formed,” or “formed, not validated” in the list of entities retrieved in step 706. If there are new or acquired entities with the status of “approved, not validated” or “formed, not validated,” the “Approved not validated or formed not validated” branch is followed to step 724, where the system 100 generates a corresponding icon to begin the validation process. The process then continues from step 724 to step 732. On the other hand, if there are entities with the status of “approved, not formed,” the “Approved, not formed” branch is followed to step 726, where the system 100 generates a corresponding icon to insert the formation date for the entity. In step 728, an inquiry is conducted to determine if the formation date has been received by the system 100. If the formation date has not been received, the “NO” branch is followed to step 728. Otherwise, the “YES” branch is followed to step 730, where the system 100 generates a corresponding icon to begin validation.

In step 732, the system 100 lists each entity with its entity ID, entity name, preparer, department, and deal closure date in an “Approved entities” datasheet table. A copy of the “Approved entities” datasheet table is provided in FIG. 7B. The dashboard datasheet tables are published on the dashboard in step 734. In step 736, an inquiry is conducted to determine if there are any dashboard alerts for the requester. If there are dashboard alerts for the requester, the “YES” branch is followed to step 738 of FIG. 7A where the dashboard alerts are listed.

Exemplary types of dashboard alerts for the transaction support group include, but are not limited to SPE's awaiting final documents; datasheets submitted; SPE's with leavers; SPE's approvals pending; and SPE conditions outstanding. Exemplary types of dashboard alerts for the accounting policy group include, but are not limited to approvals pending; final opinion pending; reassessments pending; and trigger event approvals pending. Exemplary types of dashboard alerts for the sponsor and/or preparer include, but are not limited to incomplete datasheets; acknowledgements pending; SPE's awaiting final documents; and SPE's awaiting certification. Exemplary types of dashboard alerts for the approvers and the chief financial officer include, but are not limited to approvals pending. Exemplary types of dashboard alerts for the responsible party include, but is not limited to SPE conditions outstanding.

Returning to step 736, if there are not any dashboard alerts for the requester, the “NO” branch is followed to step 740 of FIG. 7A, where the system 100 generates and presents a validation icon. In step 742, the system 100 generates and presents a conditions on approval icon. In one exemplary embodiment, the conditions on approval icon provides a link to the conditions provided by the assigned group of approvers. The process continues from step 742 to step 220 of FIG. 2.

FIG. 8 is a logical flowchart diagram illustrating an exemplary computer-implemented method for conducting a SPE entity or transaction validation as completed by step 235 of FIG. 2. Now referring to FIGS. 2 and 8, the exemplary method 235 begins with the system 100 accepting a selection of the SPE entity validation icon on the digital dashboard in step 805. In step 810, information for the selected entity or transaction is retrieved from the datasheet for that entity or transaction. The fields of the entity validation form are populated with the information retrieved from the datasheet for the selected entity or transaction in step 815.

In step 820, an inquiry is conducted to determine if all of the fields for the SPE entity validation form are populated and correct. If all of the fields in the entity validation form are not populated or not correct, the “NO” branch is followed to step 820. Otherwise, the “YES” branch is followed to step 825, where the validation button is enabled. In step 830, the user selects the validation button and the system 100 moves the entity or transaction information into the historical database 105. In one exemplary embodiment, all of the data in all of the data fields for the SPE datasheet is stored in the historical database 105. The process continues from step 830 to step 240 of FIG. 2.

FIG. 8A is an alternative logical flowchart diagram illustrating an exemplary computer-implemented method for conducting a company entity validation as completed by step 235 of FIG. 2. Now referring to FIGS. 2 and 8A, the alternative method 235A begins with the system 100 accepting a selection of the company entity validation icon on the digital dashboard in step 835. In step 840, information for the selected company entity is retrieved from the datasheet for that entity. The fields of the entity validation form are populated with the information retrieved from the datasheet for the selected entity in step 845.

In step 850, an inquiry is conducted to determine if all of the fields for the entity validation form are populated and correct. If all of the fields in the company entity validation form are not populated or not correct, the “NO” branch is followed to step 855. In step 855, an inquiry is conducted to determine if the user wants to save the entity validation form and complete it at a later date or time. If the user wants to complete the entity validation form later, the “YES” branch is followed to step 860, where the entity validation form is saved. In step 865, the system 100 allows the company entity validation form to remain in a saved format for an unspecified, extended period of time. Returning to step 855, if the user does not want to complete the company entity validation form later, the “NO” branch is followed to step 870 where the system 100 awaits the remaining fields to be populated or can request that the remaining fields be populated.

Returning to step 850, if all of the fields in the company entity validation form are populated and correct, the “YES” branch is followed to step 873. In step 873, the system 100 accepts confirmation that the information in the validation form is complete and accurate. In one exemplary embodiment, a user completes this confirmation on a line-by-line basis by selecting and placing check marks in a series of boxes on the display. In step 875, the validation button is enabled. In step 880, the user selects the validation button and the system 100 moves the predetermined fields of company entity information into the historical database 105. In one exemplary embodiment, only data from a portion of the data fields in the company entity datasheet is saved into the historical database 105. The process continues from step 880 to step 240 of FIG. 2.

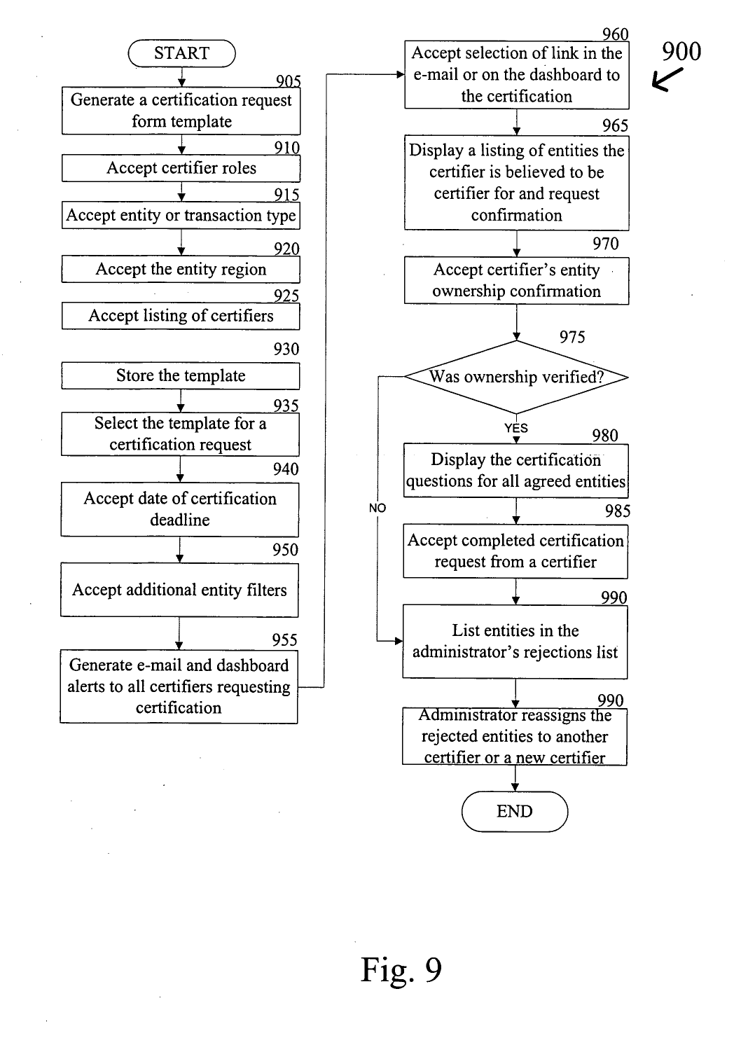

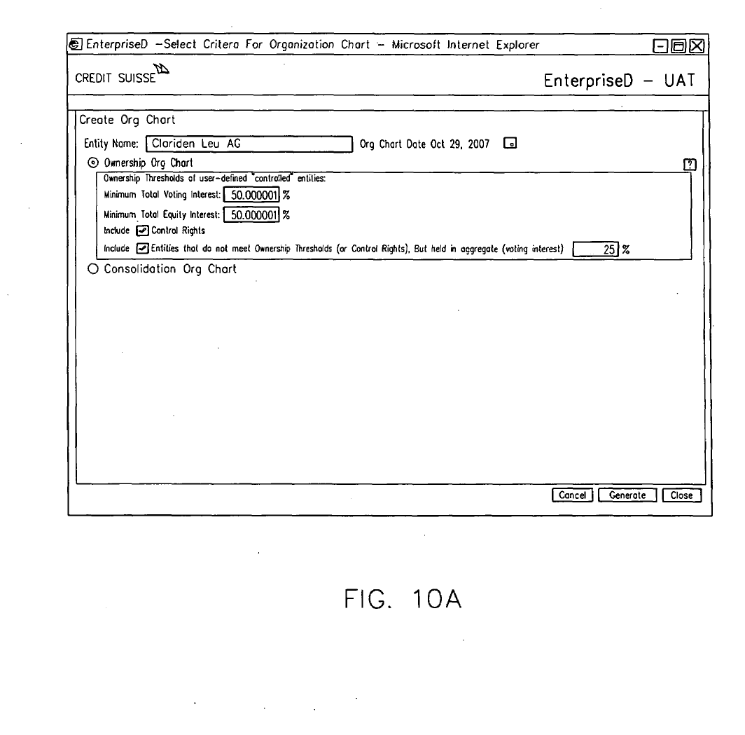

FIG. 9 is a logical flowchart diagram illustrating an exemplary computer-implemented method for generating a certification request for an entity or transaction involving an entity and receiving responses to that request within the operating environment of the current system 100. Now referring to FIG. 9, the exemplary method 900 begins at the START step and proceeds to step 905, where a certification request form template is generated. In one exemplary embodiment, the certification request form is generated based on a user's selection from the digital dashboard. For new certification templates, the user provides a template name, which is a unique name given to each certification template and is selected by the user each time the user wants to start a new certification period.

In step 910, the certification type is accepted by the system 100. In one exemplary embodiment, each certification type has a different set of certification questions, certifiers and certification managers associated with it. In one exemplary embodiment, the certification types include, but are not limited to, entity manager, special purpose entity sponsor, SPE's and mutual funds, and regional controller. The system 100 accepts the entity or transaction type for the entity that will be certified in step 915. The region and region type for the entities to be certified are accepted in step 920. In one exemplary embodiment, the region types include, but are not limited to, transaction support, corporate secretary, regional management, and consolidation regions. Regions can include, but art not limited to, global, Americas, Asia/Pacific, EMEA, and Switzerland. One or more regions may be selected for the certification process.

In step 925, one or more drop-down boxes may be provided to allow a user to select a group of certifiers. The template is stored in step 930. A template is selected for completing a certification request in step 935. In one exemplary embodiment, the system 100 stores all current and archived certifications. The current certifications are typically organized by certification name and displayed as a link. Upon selection of the link, the details of that particular certification request are displayed. The link to the archived certifications provide a user with access to historical certification reports.

In step 940, the certifiers are automatically selected and the system 100 accepts the date of the certification deadline. In one exemplary embodiment, the information for conducting the certification include, but is not limited to, the certification period, the entity effective date, certification frequency, the certification start date, and the certification reminder date. In one exemplary embodiment, certification frequency sets forth the number of certification periods that occur within a given year. The certification frequency includes, but is not limited to, quarterly, semi-annual, annual, and ad-hoc. In step 950, once the information is received, the system 100 prompts the user to select specific entity filters, such as entity status, type, etc., to define the specific certification population. The system 100 generates an e-mail and dashboard alert to all certifiers requesting that certification of the entity be completed in step 955. In step 960, a certifier may select a link in the e-mail or on the digital dashboard to access the certification.

In step 965, the system 100 displays a listing of entities that the certifier is believed to be a financial controller for and requests confirmation of the controller status from the certifier. A certifier's entity ownership confirmation is accepted from the certifier in step 970. In step 975, an inquiry is conducted by the system 100 to determine if ownership by the certifier was verified. If not, the “NO” branch is followed to step 990. Otherwise, the “YES” branch is followed to step 980, where the certification questions for all entities upon which the certifier verified ownership are presented to the certifier on the user interface by the system 100. A completed certification request is accepted by the system 100 from a certifier in step 985. In step 990, a listing of entities for which ownership was not verified or for which the answer to verification was “NO” is generated and presented to the administrator in the administrator's rejection list. The process then continues from step 990 to the END step.

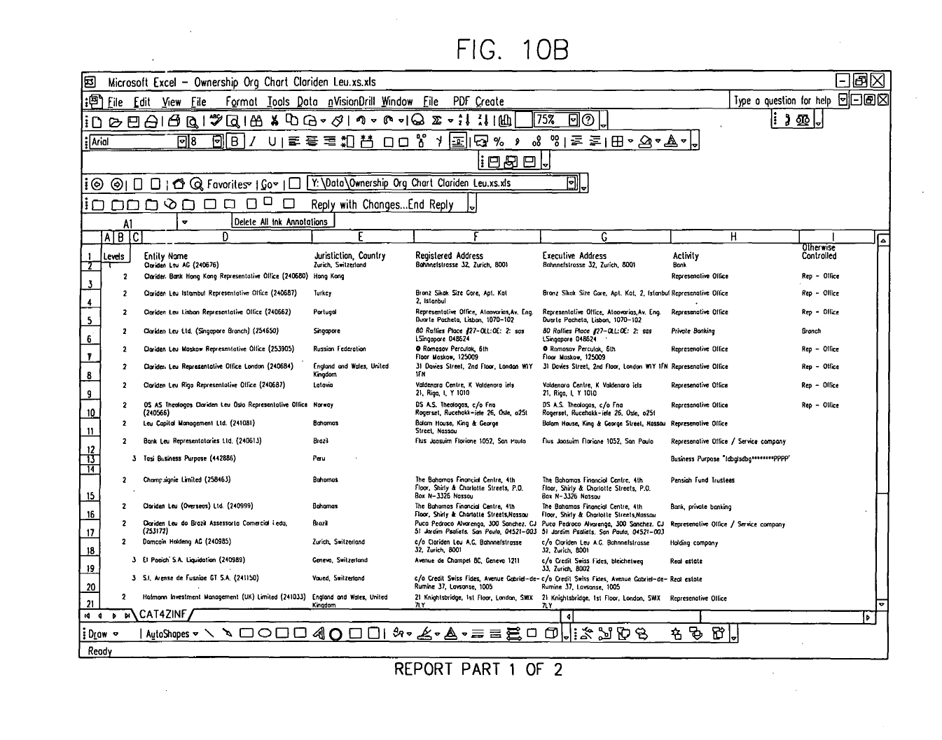

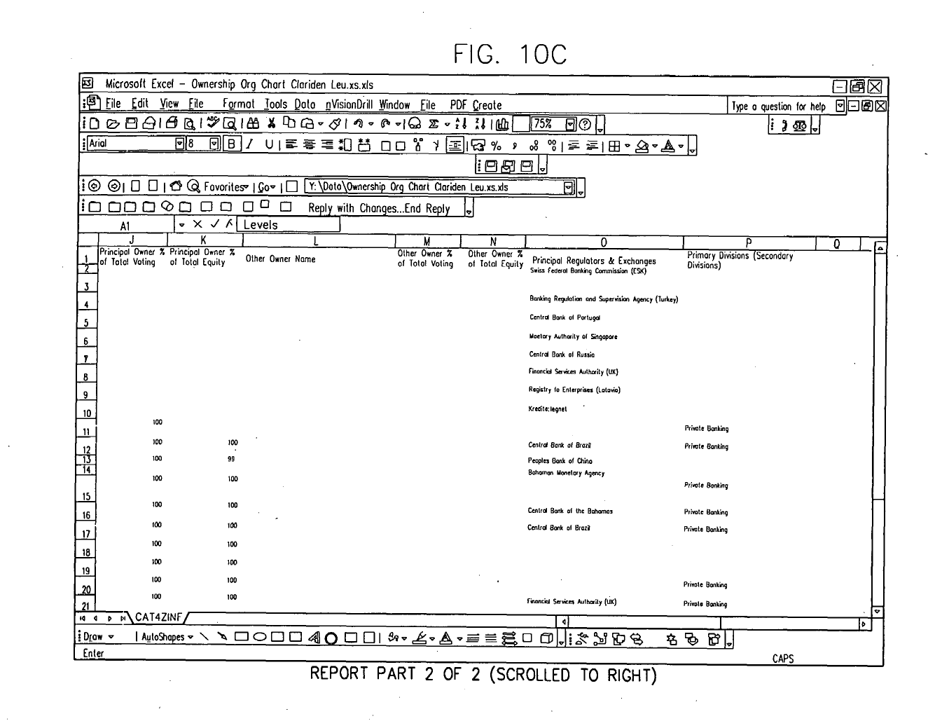

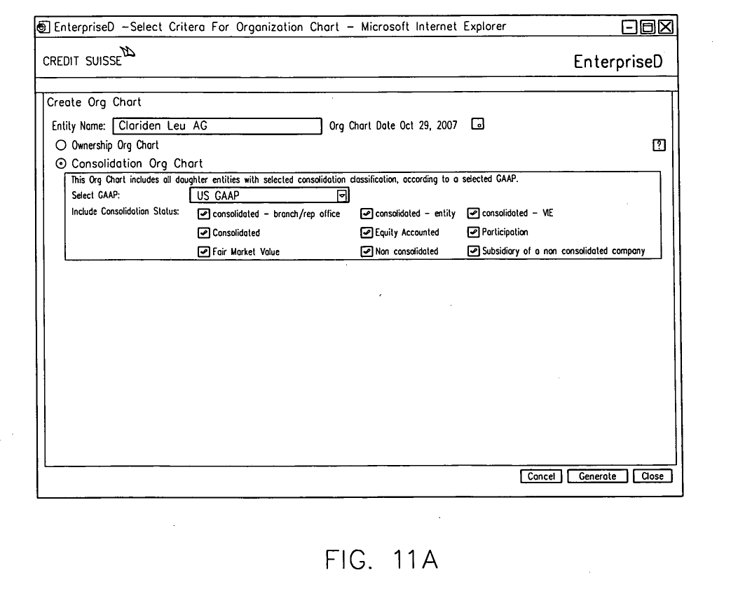

FIG. 10 is a logical flowchart diagram illustrating an exemplary computer-implemented method for generating ownership organizational charts and reports based on entity or transaction information within the operating environment of the exemplary enterprise database system 100. Referring now to FIG. 10, the exemplary method 1000 begins at the START step and continues to step 1002, where the system 100 accepts a selection requesting the generation of the ownership organizational chart on the report menu. The system 100 accepts a selection of the type of organizational chart (i.e. ownership organizational chart) that will be formed in step 1004. The system 100 accepts the total voting and total equity thresholds of the entity to be considered “controlled” in step 1005. In step 1006, the system 100 accepts one or more threshold parameters that will be used to determine which entities considered “non-controlled” will be included in the ownership organizational chart. In one exemplary embodiment, the total voting and total equity thresholds can be selected by inserting a specific percentage of total voting interest or total economic interest. An exemplary representation of the ownership organizational report is presented in FIGS. 10A and 10B.

In step 1008, the system 100 accepts additional “include”/“exclude” criteria. In one exemplary embodiment, “include” thresholds include, but are not limited to, a selection of the region, the division, the domicile for the entity, whether the entity is a branch, representative office, or small merchant banking investment. In particular, in one exemplary embodiment, the additional criteria includes criteria to determine entities that are “otherwise controlled” by an entity. A determination is made in step 1010 if each entity is included or excluded based on the accepted thresholds and criteria of steps 1005, 1006, and 1008. In step 1012, counter variable X is set equal to one. Counter variable X represents an entity in the organizational chart. The system 100 accepts the first entity in step 1014. In step 1016, an inquiry is conducted to determine if the aggregate total voting interest in the first entity is non-equal. If the voting interest in the first entity is non-equal, the “YES” branch is followed to step 1018, where the entity with the highest voting interest is designated as the primary parent of the first entity. The process then continues to step 1025. On the other hand, if the voting interest in the first entity is equal, the “NO” branch is followed to step 1020.

In step 1020, an inquiry is conducted to determine if one parent of the first entity has a higher organizational level. If one parent does have a higher organizational level, the “YES” branch is followed to step 1022, where the parent with the higher organizational level is designated as the primary parent for the first entity. The process then continues to step 1025. Returning to step 1020, if neither parent has a higher organizational level, the “NO” branch is followed to step 1024, where the system 100 determines the primary parent for the child entities according to alphabetical order. In one exemplary embodiment, the parent that is listed first in alphabetical order is designated as the primary parent.

In step 1025, for entities that have more than one parent entity, the remaining parent entities of each entity, based on interrelationality, are listed in a separate column and sorted by the highest voting interest or highest equity interest and if both voting and equity interests are equal, then alphabetically. In step 1026, an inquiry is conducted to determine if there is another entity to evaluate. If there is another entity to evaluate the “YES” branch is followed to step 1028, where counter variable X is incremented by 1. The process then returns to step 1014 to accept the next entity. Returning to step 1026, if there are no additional entities to evaluate, the “NO” branch is followed to step 1030, where the system 100 determines the branches of each entity.

In step 1032, the branch entities for each entity are listed in alphabetical order below the entity. In step 1034, a determination is made as to which entities are representative offices of each entity. The representative office entities are listed in alphabetical order below the entity in step 1036. In step 1037, the system 100 lists the child entities under the entity in alphabetical order. In step 1038, the entities that are otherwise controlled by the entity are listed in alphabetical order below the entity. The process continues from step 1038 to the END step. Those skilled in the art will appreciate that steps 1018-1025 and 1030-1038 of FIG. 10 and the associated discussion are intended to provide one exemplary embodiment of listing entities, branches, and representative offices in an ownership organization chart, and that the listing order of child entities (i.e. subsidiaries and participations), branches, and representative offices of an entity may be varied without any substantive change to the ownership organizational chart.

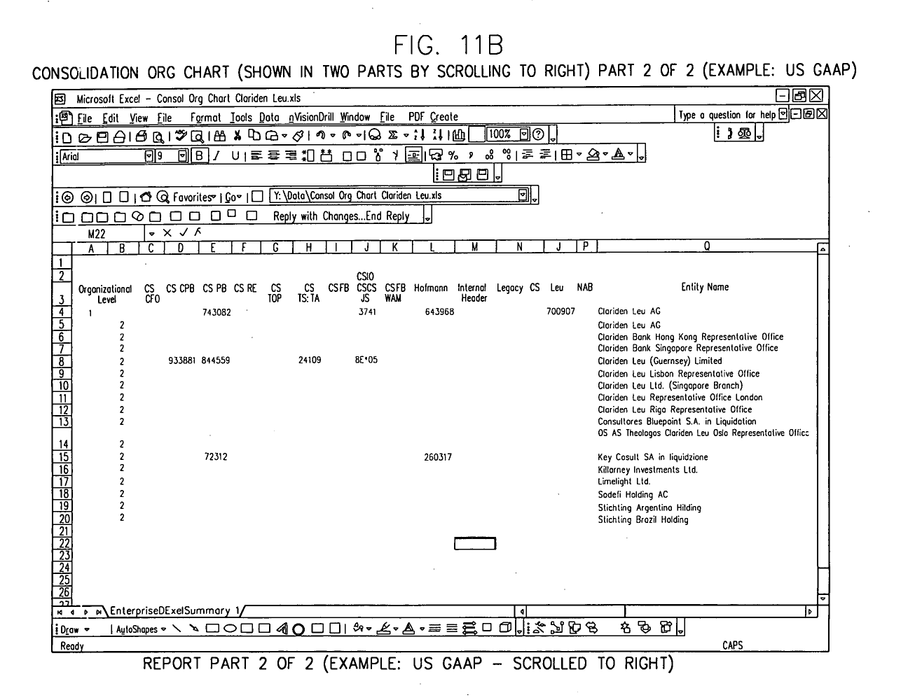

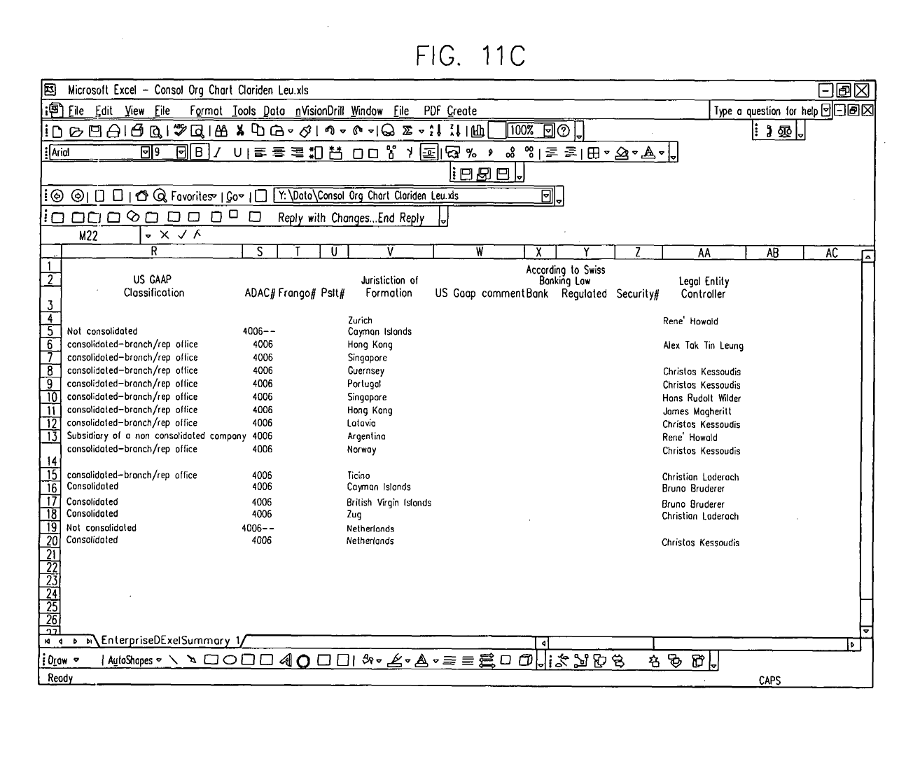

FIG. 11 is a logical flowchart diagram illustrating an exemplary computer-implemented method for generating a consolidation organization chart based on entity or transaction information within the operating environment of the exemplary enterprise database system 100. Referring now to FIG. 11, the exemplary method 1100 begins at the START step and continues to step 1102, where the system 100 accepts a selection requesting the generation of the consolidation organization chart on the report menu. A representative example of selecting and creating the consolidation organizational chart is represented in FIGS. 11A-F. The system 100 accepts a selection of the type of consolidation organizational chart that will be formed in step 1104. In step 1106, the system 100 accepts the entity. The system 100 accepts the consolidation generally accepted accounting principles (“GGMP”) in step 1108. In step 1110, the system 100 accepts one or more criteria that will be used to determine which organizations or entities will be included in the consolidation organizational chart. An exemplary representation of the consolidated organizational chart and its creation is provided in FIGS. 11A-F.

A determination is made in step 1112 if each entity is included or excluded based on the accepted criteria. In step 1114, the system 100 lists all of the child entities that have a consolidation relation to the selected entity based on the selected consolidation status and the selected GAAP in alphabetical order by entity name. Representative examples of the consolidation status options that can be selected when United States GAAP is selected include, but are not limited to, consolidated—subsidiary; consolidated—branch/representative office; equity accounted; fair market value; cost accounted; non variable interest entity—not consolidated; variable interest entity—consolidated; variable interest entity—not consolidated. Representative examples of the consolidation status options that can be selected when Swiss GAAP is selected include, but are not limited to, consolidated—subsidiary; consolidated—branch/representative office; equity accounted; not consolidated; participation; variable interest entity—consolidated; fair market value.

In step 1116, for each child entity listed under the selected entity, the system 100 lists in alphabetical order by entity name all of the child entities that have a consolidation relation to the selected entity based on the selected consolidation status and the selected GAAP. In one exemplary embodiment, the process of selecting each entity listed in the previous step and listing all the other entities that have a consolidated relation continues until the entities listed beneath do not have additional entities that have a consolidation interest.

In step 1118, an inquiry is conducted to determine if any of the listed child entities have more than one parent. If so, the “YES” branch is followed to step 1120, where each child entity is listed under every parent entity for which it is a child. Otherwise, the “NO” branch is followed to step 1122. In step 1122, an inquiry is conducted to determine if there is another parent entity to evaluate. If there is another parent entity, the “YES” branch is followed to step 1124 where the system 100 selects the next parent entity. The process then returns to step 1114. Returning to step 1122, if there are no additional parent entities, the “NO” branch is followed to step 1126, where the system 100 lists all other parents of each entity, based on interrelationality, in a separate column in the report, sorted by highest voting interest or highest equity interest, and if both equity and voting interest are equal, then alphabetically. The process continues from step 1126 to the END step.

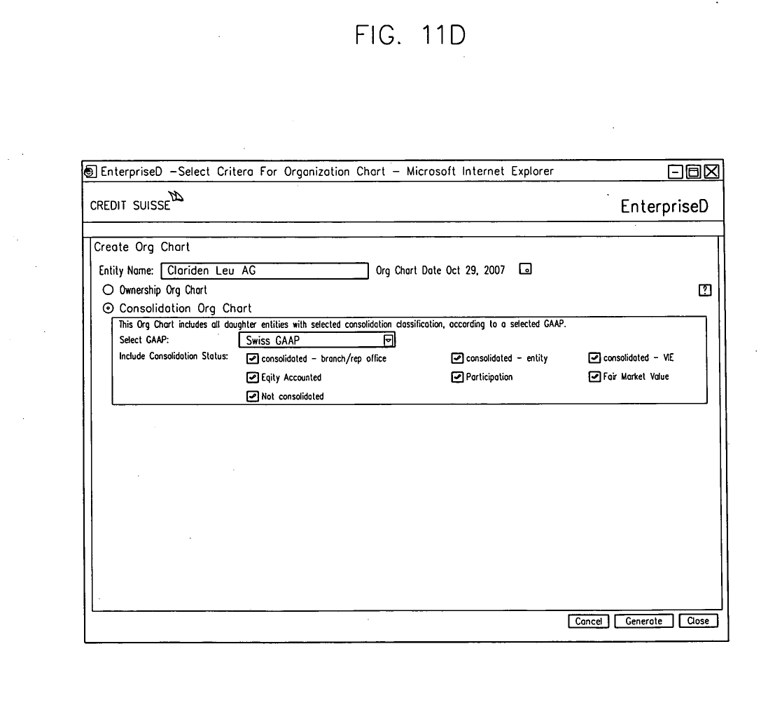

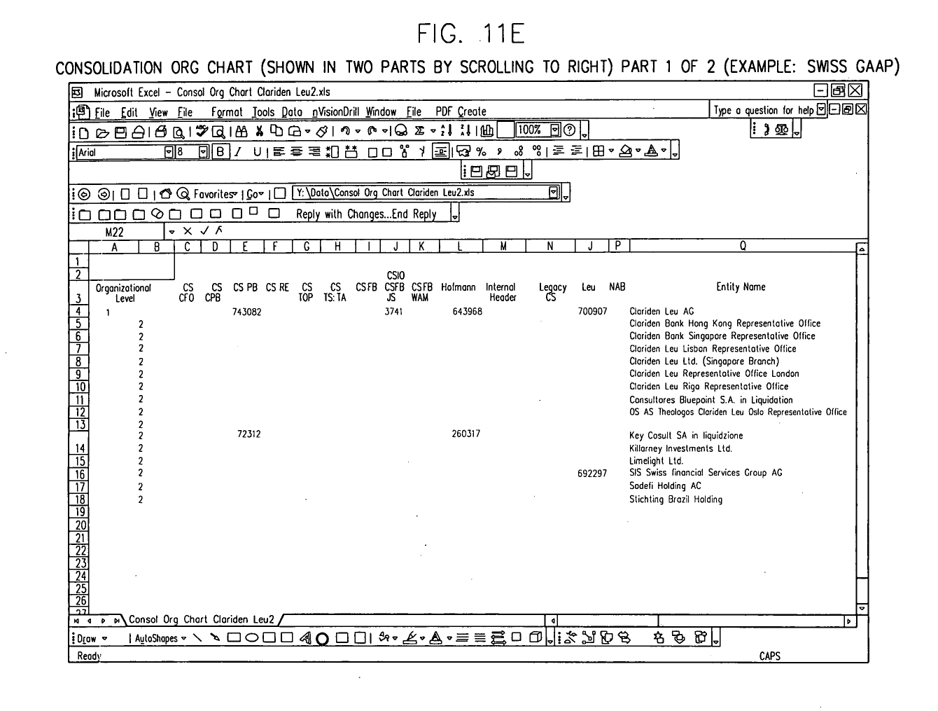

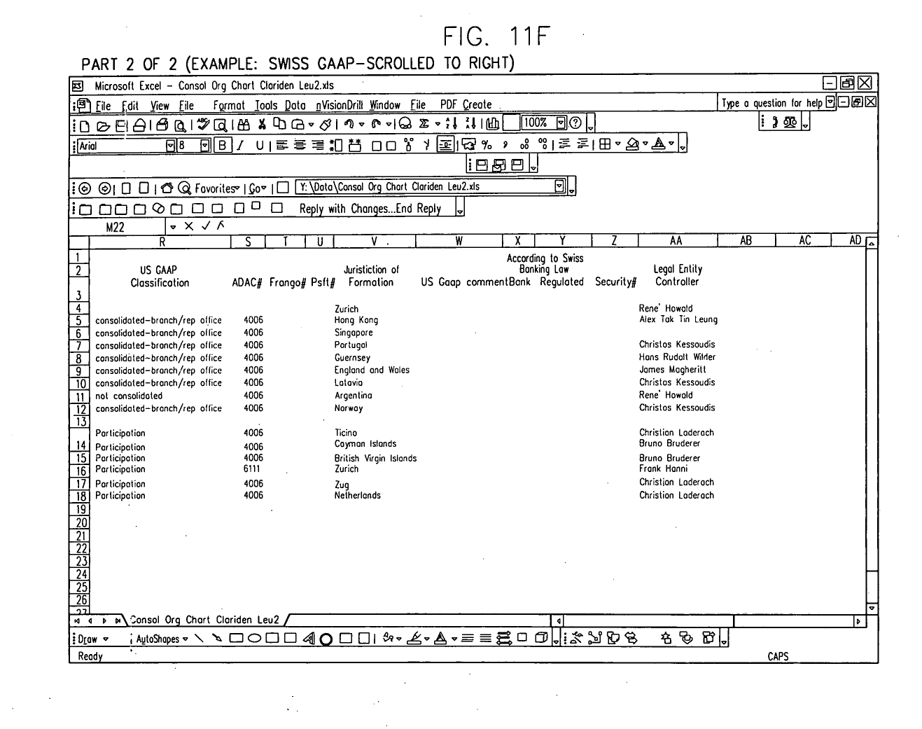

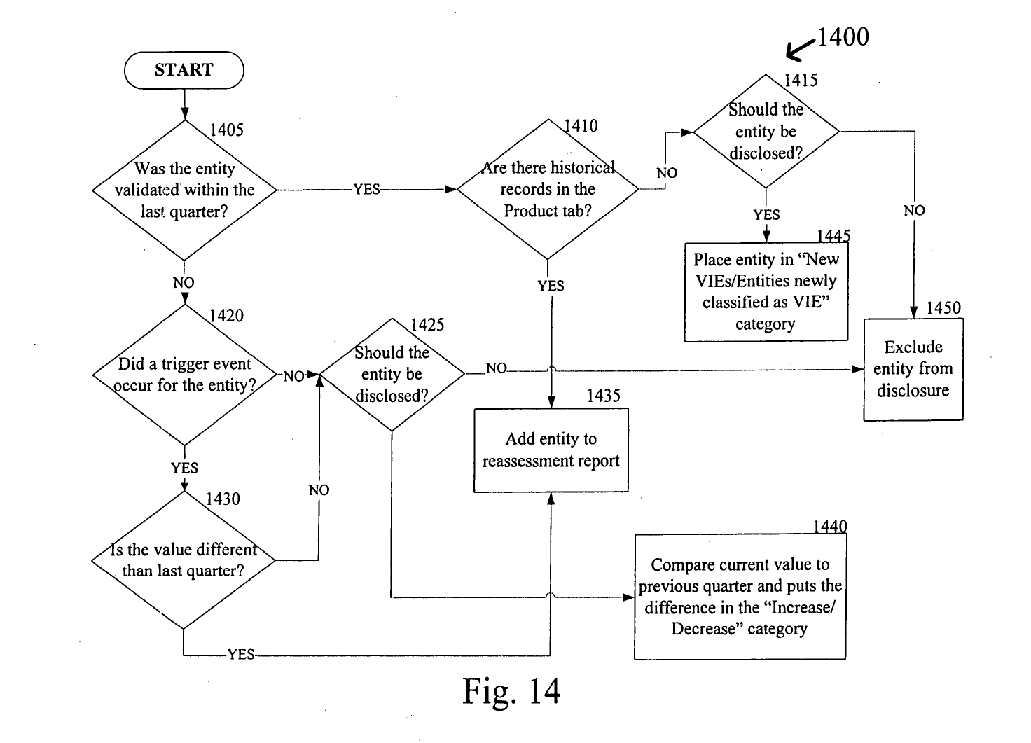

FIG. 12 is a logical flowchart diagram illustrating an exemplary computer-implemented method for generating ad-hoc reports based on entity or transaction information within the operating environment of the current system 100. Referring now to FIG. 14, the exemplary method 1200 begins at the START step and continues to step 1205, where the system 100 generates the ad-hoc reporting menu or the system 100 retrieves saved criteria for a search. In one exemplary embodiment, the saved criteria is based on a prior search and is obtained from the database 105 based on a user request. If saved criteria from a prior search is retrieved, the process continues to step 1275. Otherwise, in step 1210, the entity type is selected and the system 100 accepts the mandatory fields, including the “edit as of date” field. FIG. 12B is an exemplary illustration of a screenshot of the ad-hoc reporting menu user interface as presented by the system 100. In one exemplary embodiment, the mandatory fields are populated by a user of the system 100. The “edit as of date” field allows a user to search for reports that show information about an entity as of a selected date in the past based on the date input by the user.

In step 1215, the system 100 accepts the mandatory baseline data in the mandatory data fields. In one exemplary embodiment, the mandatory data fields include the edit as of date, entity category, entity type and entity status. In step 1220, an inquiry is conducted to determine if all of the mandatory fields in the ad-hoc reporting menu have been populated. If not, the “NO” branch is followed to step 1220 to await population of the mandatory data fields. Otherwise, the “YES” branch is followed to step 1222. In step 1222, the filter selection fields are displayed based on user permissions. In one exemplary embodiment, each filterable field has an assigned security level to it and each user of the system 100 has an assigned security level. If the security level of the user satisfies the security level of the filterable field (for example it is the same as or higher than the security level for the filterable field), the filterable field will be displayed for selection by the user. Thus, in one exemplary embodiment, a user of the system 100 is only able to see those fields that the user has permission to view. Those of ordinary skill in the art will recognize that several alternative methods for restricting the access of a user to seeing or searching by the field are available within the conventional arts and are considered within the scope of this invention.

In step 1225, the system 100 accepts a filter selection from a listing of available filters. Upon selection of a filter from the available filters list, the system 100 moves the selected filter to the listing of selected filters in step 1230 and generates a listing of available values for the selected filter in the “available values” box in step 1235. A user selects a value for the filter in step 1240. Examples of filters include, but are not limited to, deal date, division, entity ID, entity name, country of jurisdiction or formation, acquisition date, country, sponsor product, regional management region, etc.

In step 1245, an inquiry is conducted to determine if another filter is selected. If another filter is selected, the “YES” branch is followed to step 1225 to accept the next filter selection. On the other hand, if another filter is not selected, the “NO” branch is followed to step 1247. In step 1247, the system 100 accepts the fields that will be included in the report by receiving a selection of one or more fields in the “hidden fields” box and moving the selected field(s) to the “viewable fields” box. The order of the fields in the ad-hoc report can be reorganized by modifying the order of the fields in the “viewable fields” box in step 1250.

In step 1255, the system 100 accepts the selection of the “show criteria” button, requesting the generation and display of the criteria selected for the report. A summary of the report criteria is generated and displayed in step 1260. In step 1265, the “generate report button is selected by the user. In step 1270, the user is provided with the opportunity to save the report parameters for subsequent use. In an alternative embodiment of step 1270, the user is provided with the ability to export the report to a spreadsheet application. In step 1275, the system 100 accepts a subsequent selection of the “generate” button.

The system 100 evaluates the historical record database 105 contents to determine the results based on the selected filters and mandatory fields in step 1280. A security subroutine determines what data the user completing the search request has authority to view. The system 100 includes security functionality that allows a user to only search and retrieve information that the user has permission to view via their database security role. In step 1285, the system 100 sorts and displays the results that the user has the authority to view based on the user's security level. In one exemplary embodiment, the results that a user can view are determined based on a comparison of the security level of the user with the security level of the particular data in the database 105. If the user's security level is higher than or equal with that of the data, the user is able to view the data. In one exemplary embodiment, the results are sorted by the entity identification number and entity name. In an alternative exemplary embodiment, the user can sort the results based on the hierarchy of viewable fields selected for the report such that the results will be sorted first by the top field in the “viewable field” box and the sort will work progressively downward through the listing of fields in the “viewable field” box. The process continues from step 1285 to the END step.

While not presented in a representative flowchart, additional search methods are provided in the inventive system 100. For example, as shown in FIG. 12A, a user may complete a quick search for entity or transaction information in the system 100 or historical database 105 by inserting a search request into the “Entity Name” or “Entity ID” search fields. In one exemplary embodiment, the user may search for an entity or transaction by inputting a name or identification number. In this example, the system 100 will search for the exact name or identification number provided by the user and will only return exact matches to the information that was input.

In an alternative embodiment, the user may employ a wildcard function by placing an asterisk on the front, back or both sides of the input search term. By placing the asterisk prior to the search term, the system 100 will search for and return results that have an ending that matches the search term. By placing the asterisk on the back side of the search term, the system 100 will search for and return results that have a beginning that matches the search term. By placing an asterisk on both sides of the search term, the system 100 will search for and return results that have the search term anywhere within that result. The search techniques described above may also be incorporated into the ad-hoc search process through the filter selection and value selection process of steps 1225-1240 of FIG. 12.

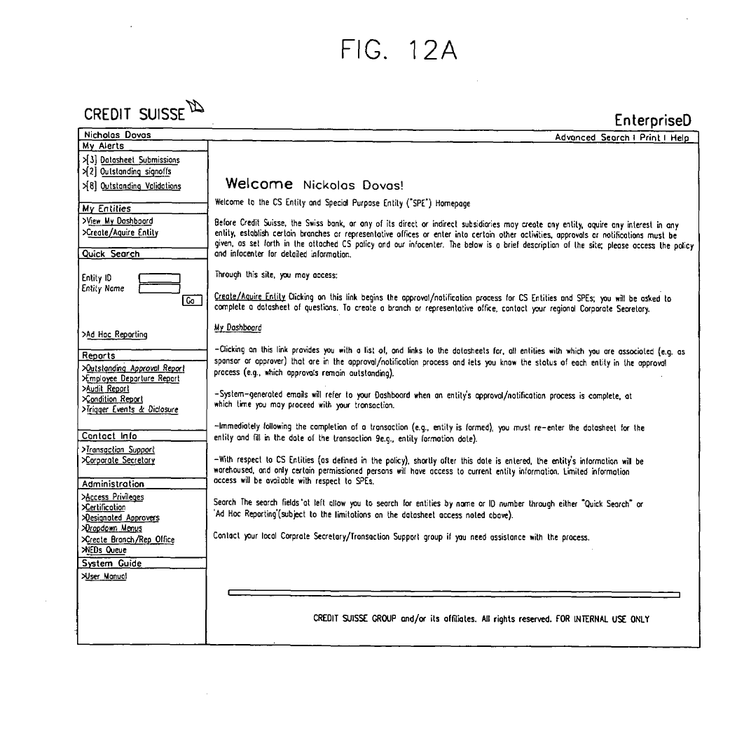

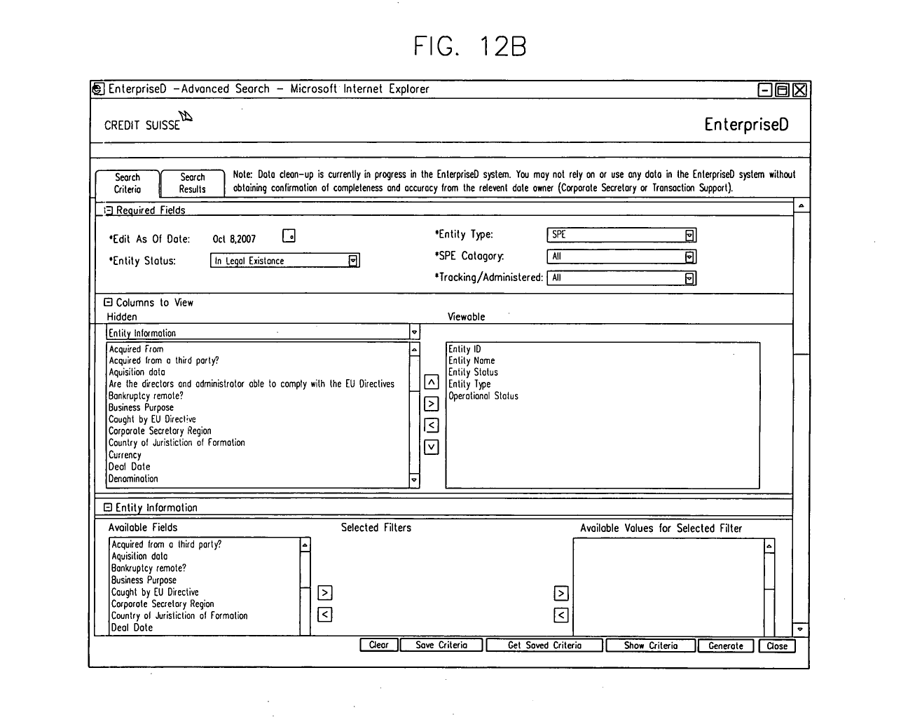

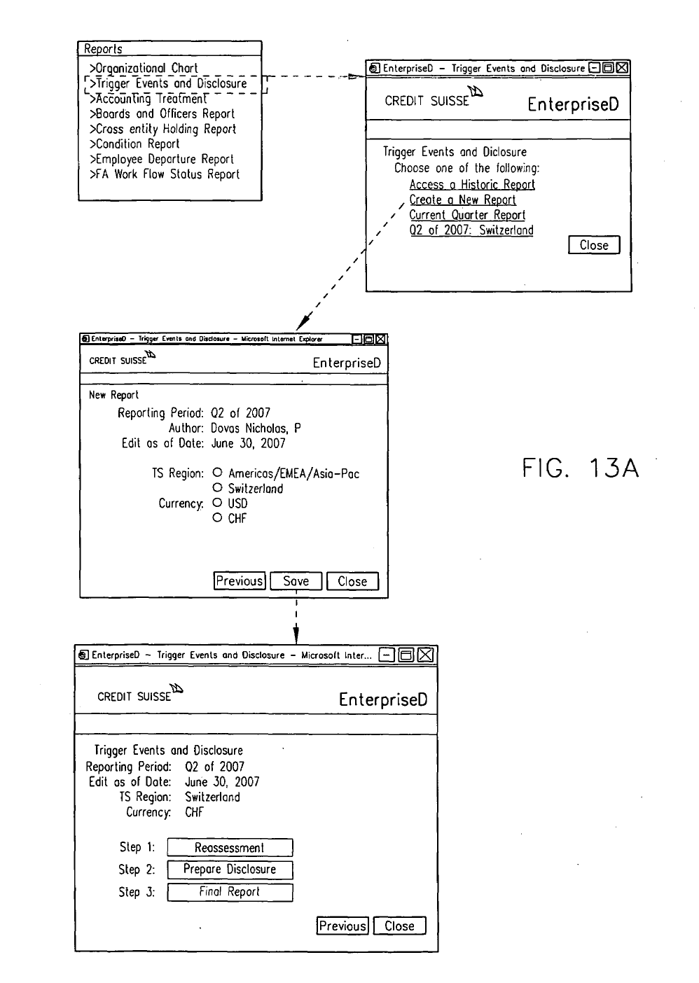

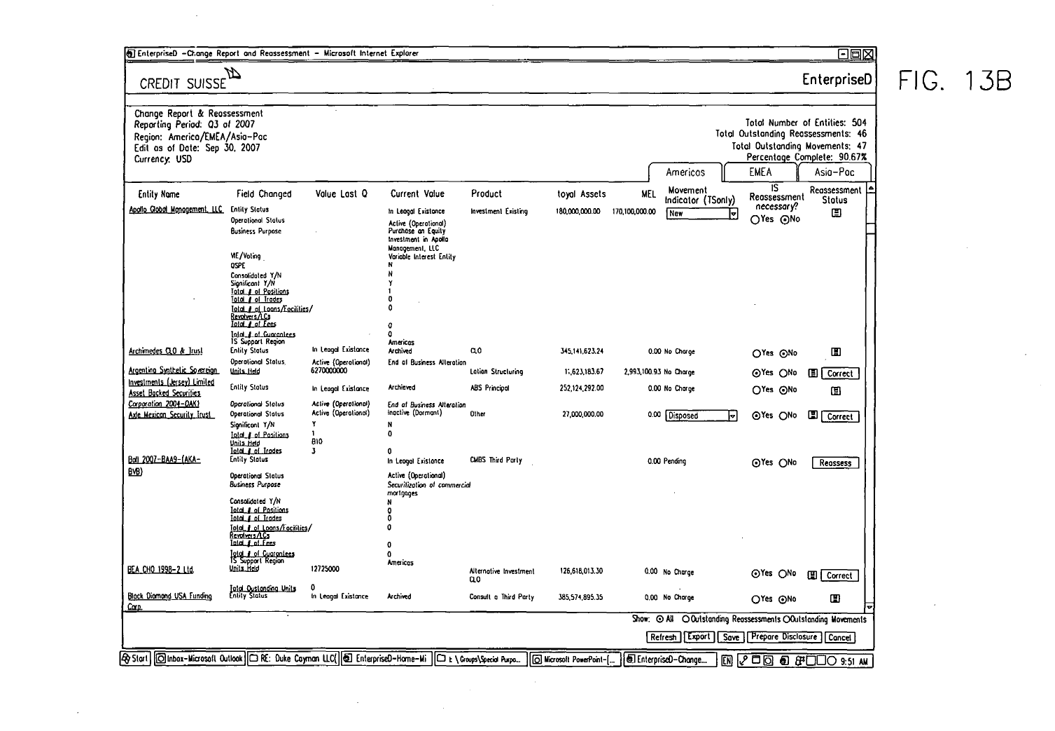

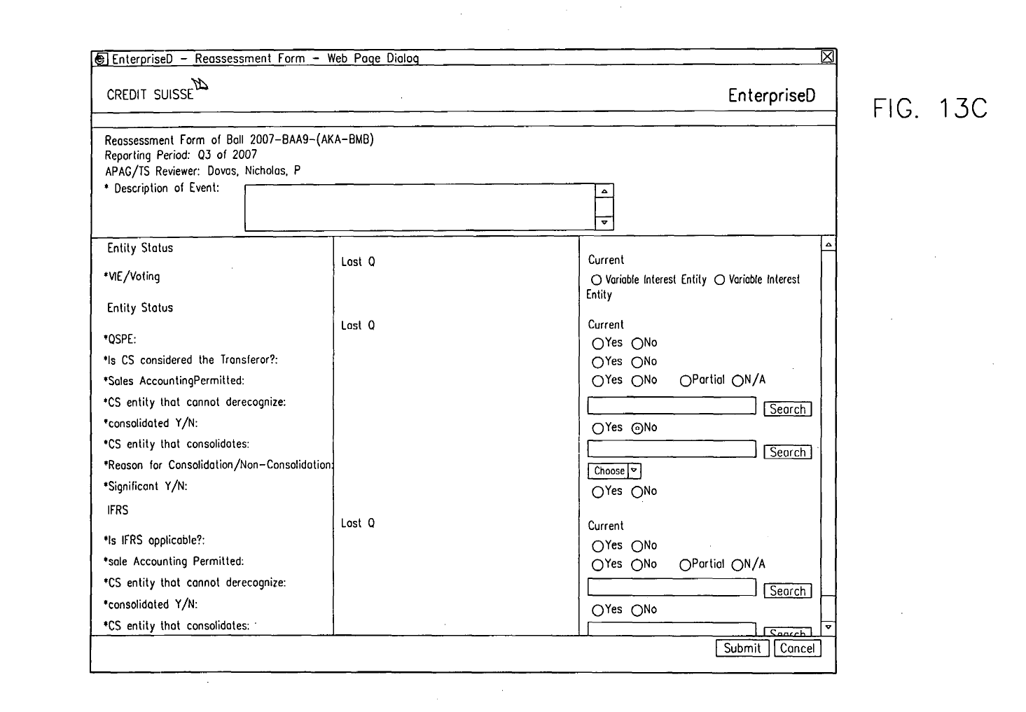

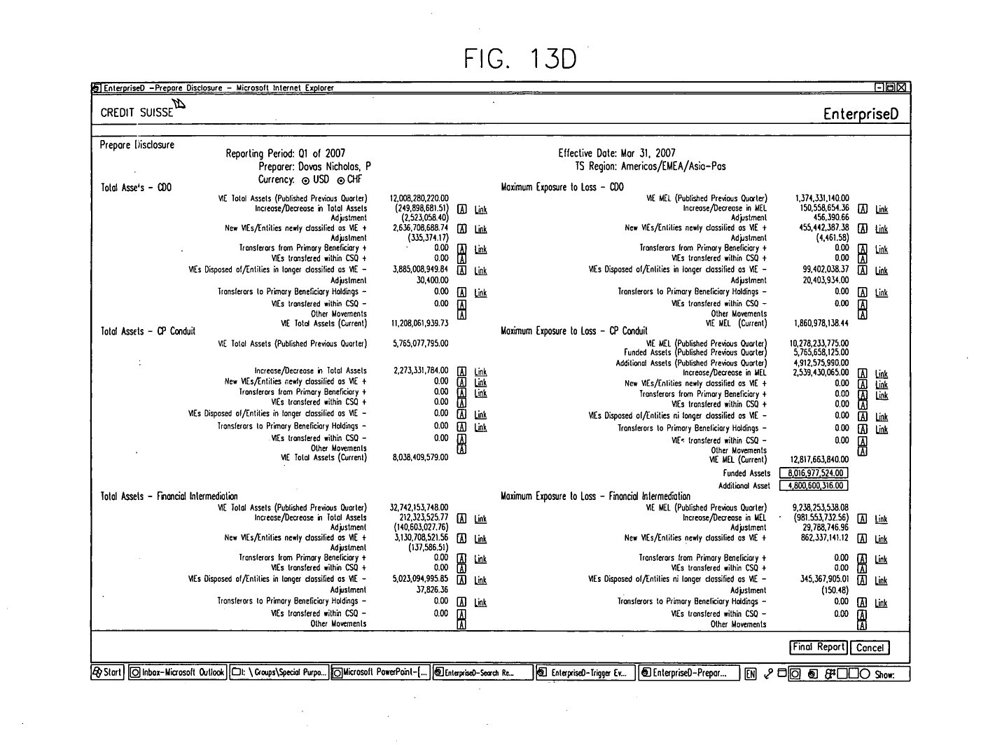

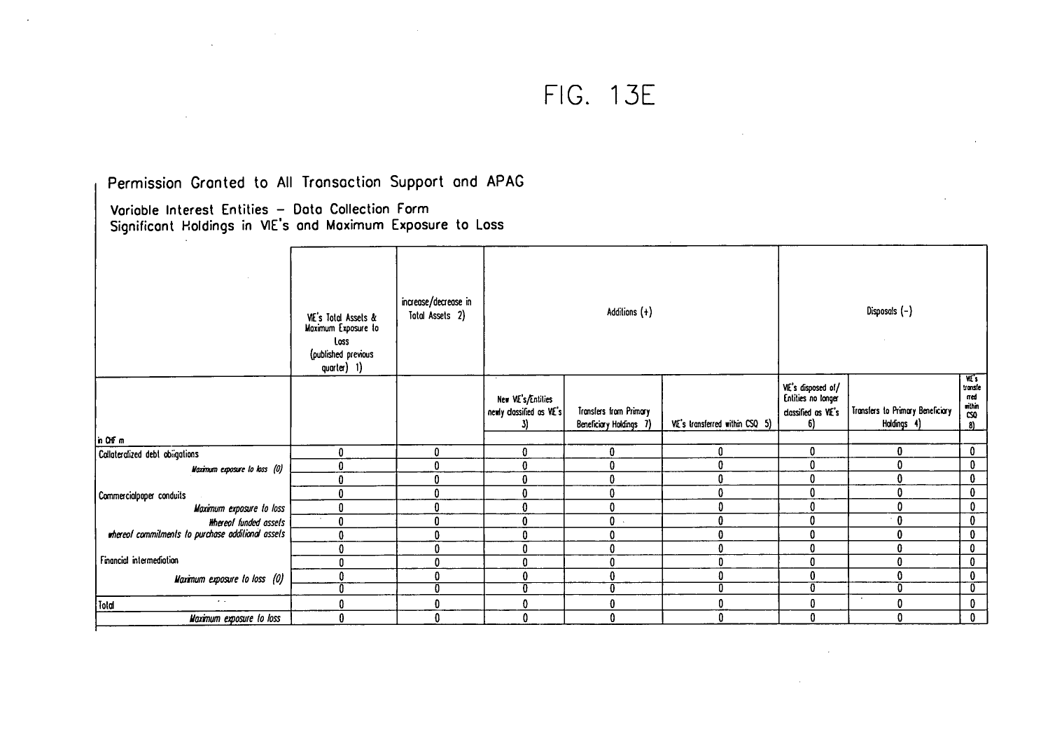

FIG. 13 is a logical flowchart diagram illustrating an exemplary computer-implemented method for reassessing entities and generating a disclosure report based on entity or transaction information within the operating environment of the current system 100. Referring now to FIG. 13, the exemplary method 1300 begins at the START step and continues to step 1302, where the system 100 generates a disclosure reporting menu. An exemplary disclosure reporting menu is provided in FIG. 13A. In one exemplary embodiment, the disclosures in the disclosure report are regarding significant variable interest disclosures according to United States generally accepted accounting procedures and Financial Accounting Standards Board Interpretation No. 46R. In step 1304, parameters for the disclosure report are accepted. In one exemplary embodiment, those parameters include the reporting period, edit date, and region to evaluate. In another embodiment, the disclosure report is generated by the system 100 automatically on a periodic basis, such as at the end of every quarter.

In step 1306, the entity information is obtained based on the selected parameters and imported into the system 100. In one exemplary embodiment, the data is imported into the enterprise system 100 from other linked data systems. This data may be received by the system 100 through automatic feeds or through templates imported into the system 100. To ensure the integrity of the data, in an exemplary embodiment, a data integrity check of the data imported into the system 100 is completed in step 1308.

In step 1310, the system 100 evaluates the trigger event fields for each entity to determine if a change has been made to one of the fields. In one exemplary embodiment, what is and is not a triggering event is based on Financial Accounting Standards Board Interpretation No. 46R. In an exemplary embodiment, these trigger event fields may include, but are not limited to, the fields listed below in Table 1.

TABLE 1
Exemplary trigger event fields.

| Trigger Event Fields | Section | Tab |
|---|---|---|
| Operational Status: | Company | Entity |
| | Entity | Information |
| | Information | |
| Entity Status: | Company | Entity |
| | Entity | Information |
| | Information | |
| Business Purpose: | Company | Entity |
| | Entity | Information |
| | Information | |
| Transaction Support Region | Company | Entity |
| | Entity | Information |
| | Information | |
| Is the entity a variable interest | Entity Type | Financial |
| entity or voting interest entity? | | Accounting |
| Does this entity qualify as a QSPE?: | USGAAP | Financial |
| | | Accounting |
| Does this entity need to be | USGAAP | Financial |
| consolidated under US GAAP? | | Accounting |
| Does company have a significant | USGAAP | Financial |
| interest in this entity? | | Accounting |
| Is this entity a tracking entity? | Transaction | Financial |
| | Support | Accounting |
| Total # of Positions: | Debt/Equity | Product |
| Units Held | Debt/Equity | Product |
| Total Outstanding Units | Debt/Equity | Product |
| % of Outstanding | Debt/Equity | Product |
| NAV per unit (Base) | Debt/Equity | Product |
| NAV own holdings (Base) | Debt/Equity | Product |
| Outstanding NAV (Base) | Debt/Equity | Product |
| Total # of Trades: | Derivatives | Product |
| NAV | Derivatives | Product |
| PRV in % of NAV | Derivatives | Product |
| Total # of | Loans/Facilities | Product |
| Loans/Facilities/Revolvers/LCs: | | |
| Committed Lending | Loans/Facilities | Product |
| Total # of Fees: | Fees | Product |
| Fee Measurement Basis | Fees | Product |
| Total # of Guarantees: | Guarantees | Product |
| Notional Amount | Guarantees | Product |

In an exemplary embodiment, the trigger event fields can be evaluated and adjusted through the product tab. However, regardless of which trigger events are specified, if the system 100 detects a change in one of the trigger event fields, the entity is added to a reassessment report (as discussed below). Accordingly, in one exemplary embodiment, the system 100 monitors entities since the last disclosure report to detect when data affecting the trigger event fields is updated. If a trigger event is detected, the entity is added to a reassessment report that can be accessed and used to produce a subsequent disclosure report.

According to an exemplary embodiment, the system 100 may allow a user to create a new report or run a pending report. When a chooses to run a pending report, the system 100 generate selectable options to perform a reassessment, prepare a disclosure report, or run a final disclosure report. In step 1312, the system 100 accepts a request to perform a reassessment by running a change report (i.e., reassessment report). In an exemplary embodiment, the reassessment report will reflect information in the database 105 for the preceding quarter and will comprise entities with changes to trigger event fields during that quarter.

For each entity listed in the reassessment report, the system 100 provides a list comprising the field that was changed, the prior entry in that field, and the current entry in that field. An exemplary version of a reassessment report is provided in FIG. 13B. By way of example, the prior entry is the value of the field from the last disclosure report (e.g., quarter) and the current entry is the value of the field at present. Additionally or alternatively, an entity is only listed in the reassessment report if the value of the prior entry field and current entry field are different. That is, even if the system 100 detects a trigger event during the time selected that is covered by the disclosure report (e.g., the last quarter), the system 100 will only display the entity in the reassessment report if the prior entry value and the current entry value for the trigger event fields are different (as discussed with reference to FIG. 14).

In step 1314, each changed trigger event in the change report is evaluated to determine if a reassessment of the entity or transaction is necessary. In step 1316, an inquiry is conducted to determine if a reassessment by the accounting policy group for the entity or transaction is necessary based on the change in the trigger event. If a reassessment is necessary, the “YES” branch is followed to step 1318, where the system 100 accepts selection of the voting button requesting reassessment of an entity or transaction. The reassessment is completed in step 1320. In one exemplary embodiment, the reassessment of the entity or transaction is completed by the accounting policy group. This reassessment is performed through a reassessment form generated by the system 100. An example of a reassessment form is illustrated in FIG. 13C.

In step 1322, an inquiry is conducted to determine if the opinion of the accounting policy group is revised. If the opinion is not revised, the “NO” branch is followed to step 1328. Otherwise, the “YES” branch is followed to step 1324, where the revised opinion is saved as a new historical opinion in the database 105 and the database 105 registers the revised opinion as an update. In step 1326, the reasons for the changes to the opinion are accepted by the system 100. The process continues from step 1326 to step 1330. Saving the reassessment performed by the accounting policy group and the reasons for the changes allows a member of a transaction support group or other party to review the changes at a later time and either accept or amend the reassessment. Further, according to an exemplary embodiment, at any time during the reporting process, a sample disclosure report is generated based on the changes made to the entities without generating a final report. In this way, the changes to the entities can be viewed instantaneously as the changes are performed. The system 100 can generate a sample disclosure report by storing the reassessment report and accepting a request to prepare a disclosure report. In one exemplary embodiment, an option to generate a sample disclosure report is displayed on the disclosure reporting menu provided by the system 100. An exemplary menu for running a reassessment report and disclosure report is illustrated in FIG. 13A.

Returning to step 1316, if a reassessment of the entity or transaction is not necessary, the “NO” branch is followed to step 1328. In step 1328, if reassessment was not completed or the opinion was not changed, the determination of whether the entity or transaction should be added to a disclosure report is based on whether the entity or transaction was disclosed in the prior disclosure report for the prior reporting period. However, if the entity is newly created and is of significant interest, it may be displayed in the report despite not being previously disclosed (as discussed with regard to FIG. 14).

In step 1330, the system 100 accepts the product category for each entity that was reassessed. In one exemplary embodiment, the product categories include, but are not limited to, commercialized debt obligation (“CDO”), commercial paper conduit (“CP Conduit”), and financial intermediates. In step 1332, the total assets for each entity or transaction to be disclosed are accepted. The maximum exposure to loss for each entity to be disclosed is accepted in step 1334.

In step 1336, an inquiry is conducted to determine if any of the values of the report need to be edited. In one exemplary embodiment, the user generating the report, which may be transaction support, has the capability to edit values prior to finalizing and printing or exporting the disclosure report to another application or system 100. If the values will be edited, the “YES” branch is followed to step 1338, where the system 100 accepts edits to the values of one or more fields in the disclosure report. Otherwise, the “NO” branch is followed to step 1340, where the system 100 generates the disclosure report. An exemplary disclosure report and additional information related to the creation of the disclosure report is included in FIG. 13D. With the report ready to be finalized, the process continues from step 1340 to the END step. An example of a final report is illustrated in FIG. 13E.

FIG. 14 is a logical flowchart diagram illustrating an exemplary computer-implemented method for determining whether an entity should be included on a reassessment report and disclosed using information within the operating environment of the current system 100. In particular, FIG. 14 illustrates an exemplary method that may be particularly useful for determining whether company entities and/or special purpose entities should be reassessed. In one exemplary embodiment, company entities are those entities that the monitoring company has at least 20% of the voting interest, 25% of the economic interest, or other control rights such as a majority of the board members.

According to an exemplary embodiment, the system 100 tracks and receives updated data for entities tracked by the system 100. The exemplary method 1400 begins at the START step and continues to step 1405. At step 1405, the system 100 determines whether the entities stored in the system 100 were validated within the last quarter. If so, the “YES” branch is followed to step 1410, where the system 100 determines if there are historical records in the products tab. If the entity has been disclosed before, then the “YES” branch is followed and the entity is added to the reassessment report in step 1435. If, instead, the entity has not been disclosed in a disclosure report during the previous reporting period, then the “NO” branch is followed to step 1415, where the system 100 determines whether the entity should be added to a disclosure report. To determine whether to add the entity to a disclosure report, the system 100 detects if the entity has been marked as one of significant interest (e.g., the system 100 looks to see if the significant interest bit is set for the entity). If the entity is marked as one of significant interest, then the “YES” branch is followed and the entity is placed in the disclosure report. In one exemplary embodiment, the entity is placed in a listing of entities categorized as “New VIEs/Entities newly classified as VIE” in the disclosure report. However, if the entity is not of significant interest (i.e., it should not be disclosed), then is the system 100 excludes the entity from the disclosure report in step 1450.

Returning to step 1405, if the entity was not validated within the last quarter, the “NO” branch is followed to step 1420b. There, the system 100 checks to see if a trigger event occurred for the entity. Examples of trigger events are listed in Table 1, above. If a trigger event is detected, the “YES” branch is followed to step 1430. If a trigger event is not detected, then the “NO” branch is followed to step 1425. There, the system 100 determines if the entity should be placed in the disclosure report despite the absence of a trigger event (as discussed below).

Returning to step 1430, the system 100 compares the current value of the trigger event field to a historical value for the trigger event field stored in the system 100. In this way, the system 100 determines whether the value for the trigger event is different than the historical value (i.e., is the value for the trigger event different than it was the last quarter). If the system 100 determines the value to be different, then the “YES” branch is followed to step 1435, where the system 100 adds the entity to the reassessment report. However, if the value of the trigger event field did not change from the last report, then the “NO” branch is followed to step 1425. Because of these steps, the system 100 will not add an entity to the reassessment report simply because the entity has had trigger events occur since the last disclosure reporting period, but the entity has returned to status quo (e.g., total number of units fluctuated during a quarter, but the total number remains the same at the end of the current reporting period as it was at the end of the prior reporting period).

In step 1425, the system 100 determines whether the entity should be placed in the disclosure report (e.g., whether the entity is of significant interest). Similar to step 1415, at step 1425 the system 100 evaluates data entries for the entity to determine if the entity has been marked as one of significant interest. If the entity is not marked as one of significant interest, then the “NO” branch is followed and the system 100 excludes the entity is excluded from the disclosure report in step 1450. However, if the entity has been marked as one of significant interest, then the “YES” branch is followed and information for the entity is added to the disclosure report. In one exemplary embodiment, the entity is categorized in the disclosure report as “New VIEs/Entities newly classified as VIE”.

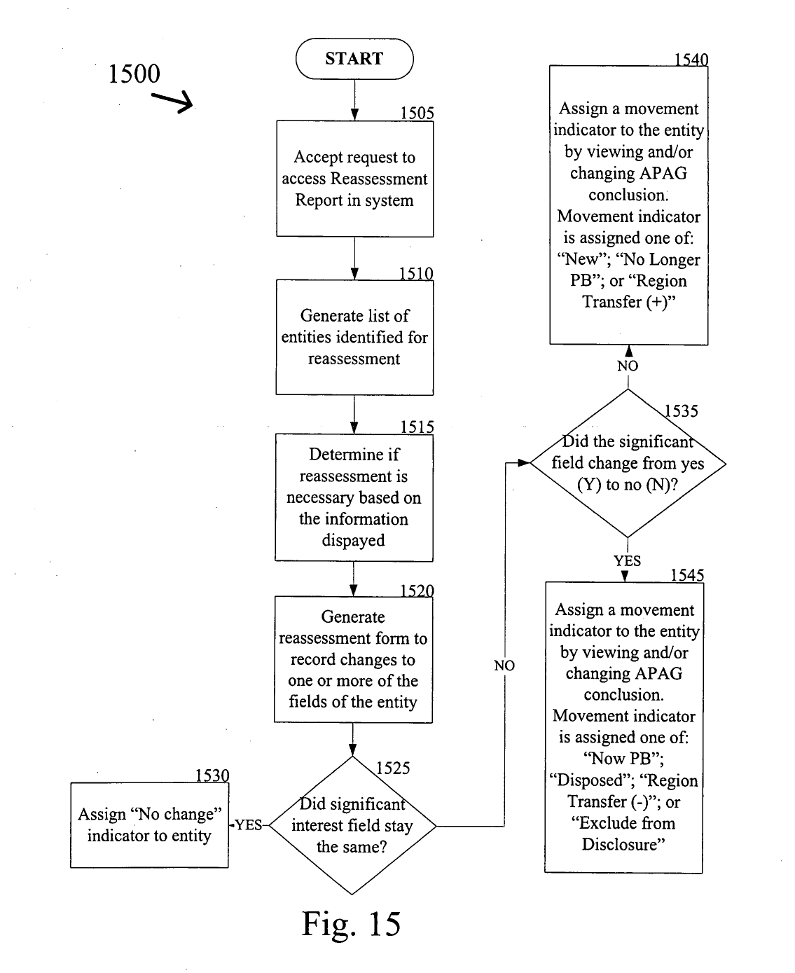

Once the system 100 determines whether the entity should be presented in the disclosure report, excluded from the disclosure report, or added to the reassessment report, it generates a reassessment request form for completing a reassessment. An exemplary embodiment of this process is illustrated in FIG. 15. Beginning at step 1505, the system 100 accepts a request to perform a reassessment of the entities for which reassessment is requested. In one exemplary embodiment, the entities are determined based on an evaluation of the reassessment report. Typically, reassessment of an entity is conducted at the end of a specified period of time, such as a quarter of a year, in order to determine if a reclassification is warranted. Once to the system 100 receives a request to access the reassessment report, the system 100 displays a list of the entities identified for reassessment in step 1510. In one exemplary embodiment, the list includes information related to the identified entities, including, but not limited to, the field changed, the prior value of the field, and the current value of the field. From this list, a determination as to whether a reassessment is necessary is made in step 1515. In one exemplary embodiment, the reassessment is performed by a member of the accounting policy group and the reassessment can be reviewed by another person, such as a member of the transaction support group.

If a reassessment request is received, the system 100 generates and displays a reassessment form at step 1520 so that changes can be made to fields applicable to the entity. These editable fields in the reassessment form may include, but are not limited to: QSPE; Sale Accounting Permitted Y/N; company entity that cannot derecognize; consolidated Y/N; company entity that consolidates; reason for Consolidation/Non-Consolidation; and Significant Y/N. In one exemplary embodiment, the system 100 accepts changes to the reassessment form from a member of the accounting policy group and stores the reassessment changes in the database 105.

At step 1525, the system 100 reviews the changes saved by the user and determines if the significant interest field remains the same for the entity after the reassessment form has been altered. If so, then the “YES” branch is followed to step 1530, where the system 100 assigns a “No change” indicator to the entity in the reassessment report to alert the reviewer (i.e., in an exemplary embodiment, a member of the transaction report group) that a reassessment is not necessary. However, if the system 100 detects that the significant interest field has changed (e.g., “Y” to “N” or “N” to “Y”), then the “NO” branch is followed to step 1535. At step 1535, the system 100 checks to determine if the significant interest field has changed from a yes, “Y”, to a no, “N”. If not, then the “NO” branch is followed to step 1540, where the system 100 supplies a drop-down box so that the reviewer (e.g., a member of the transaction support group) can specify the reassessed entity into a specific category for the disclosure report. In an exemplary embodiment, the system 100 generates a drop-down box that includes one of the following categories when the significant interest field is changed from a “Y” to a “N”: “New”, “No Longer PB,” or “Region Transfer (+)”. Similarly, if the system 100 detects that the significant interest field has been changed from a “Y” to a “N” (i.e., it has been changed from “N” to “Y”), then the system 100 will present a different set of categories for the reviewer at step 1545. According to an exemplary embodiment, these categories include, but are not limited to: “Now PB”; “Disposed”; “Region Transfer (−)”: or “Exclude from Disclosure”.

After the system 100 accepts a selection of one of the categories presented by the system 100 for each entity, the system 100 generates the draft and final versions of the disclosure report. Also, in an exemplary embodiment, a sample disclosure report may be generated by the system 100 at any time during the process by the system 100. When the option to run a disclosure report is received by the system 100, the system 100 displays the entities in the categories to which each has been assigned by the system 100 or the reviewer. Further, those entities marked by the reviewer or system 100 as “Exclude from Disclosure” will not be disclosed in the disclosure report. Once the system 100 generates a disclosure report, manual changes can be made to it. Once the report is acceptable, the system 100 generates the final disclosure report. The system 100 can export the report to another system or print it out.

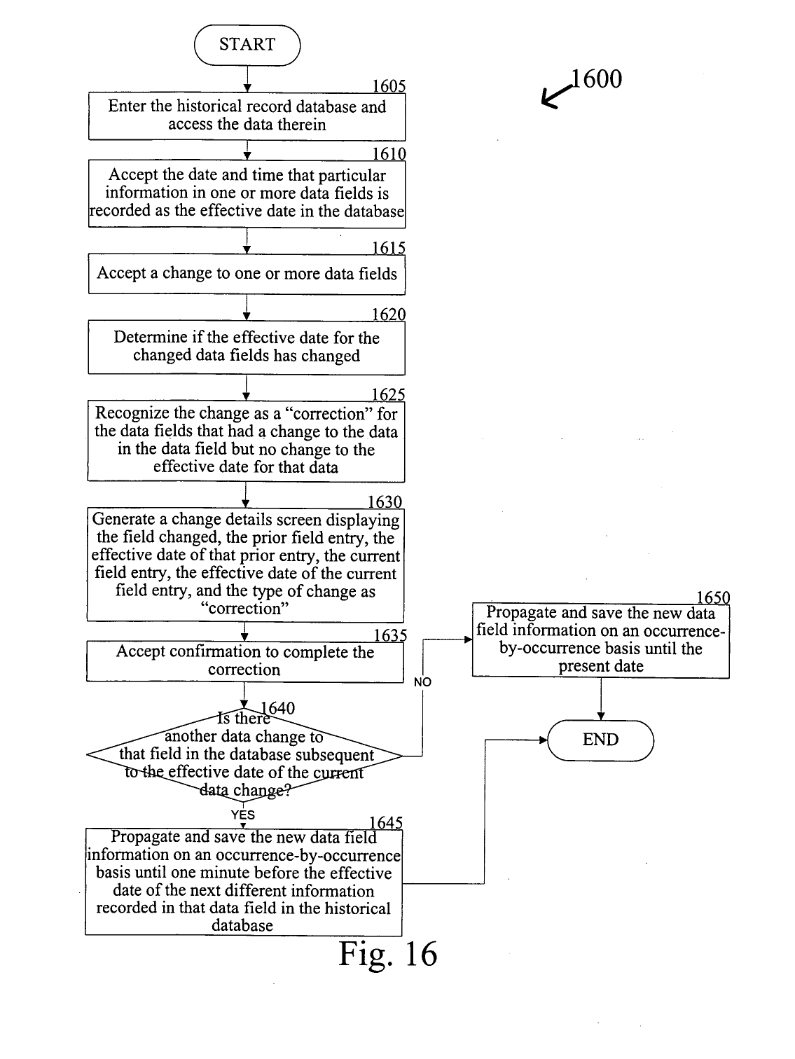

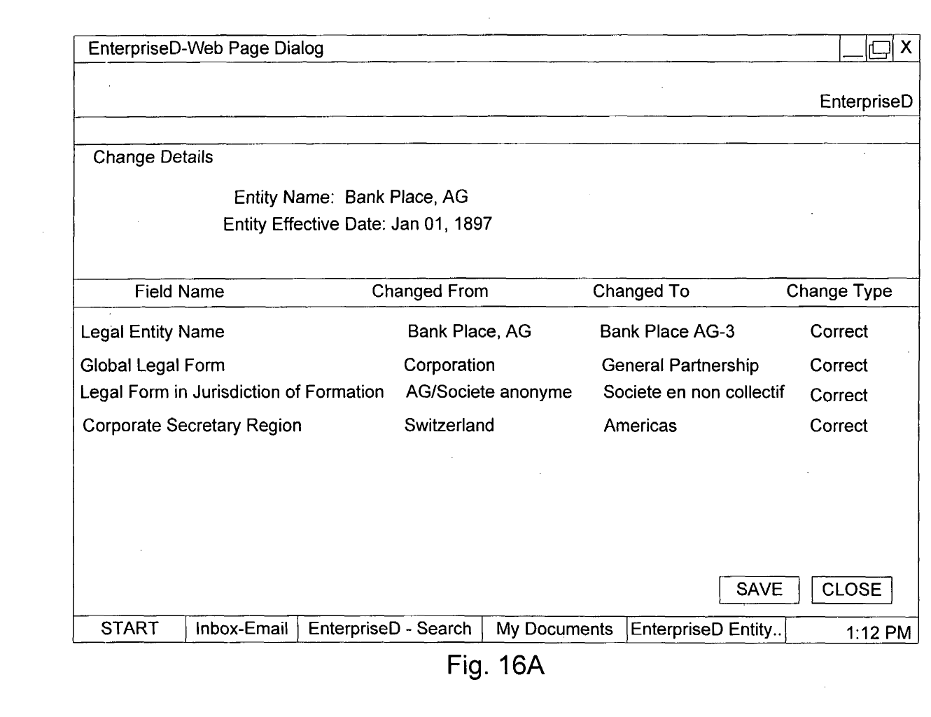

FIG. 16 is a logical flowchart diagram illustrating an exemplary computer-implemented method for completing a correction to one or more data fields in the historical database 105 within the operating environment of the current system 100. Referring now to FIG. 16, the exemplary method 1600 begins at the START step and continues to step 1605, where the user enters the historical record database 105 and accesses the data stored therein. In step 1610, the system 100 accepts the date and time that specific information in one or more data fields is recorded as the effective date in the database 105. In one exemplary embodiment, the user can select a date only and the default time for the selected date will be twelve midnight. In this exemplary embodiment, the historical database system 105 does not adjust the time based on time zones, but instead maintains a singular time period. When the user accesses the system 100 and selects a time, they will generally select a time based on the time zone in which they reside.

A change to one or more data fields is accepted by the system 100 from the user in step 1615. The system 100 determines if the effective date has changed for the data fields that were changed by the user in step 1620. In step 1625, the system 100 recognizes the change to the information in the data fields as a “correction” because the data fields had a change to the data but no change to the effective date for that data. In another exemplary embodiment, if the data field did not previously contain data and the user goes in and puts data into that data field, the system 100 would recognize the insertion as a correction, no matter what date is selected. In step 1630, the system 100 generates a change details report displaying the fields that were changed. In one exemplary embodiment, the change details report includes, the prior field entry, the effective date of the prior field entry, the current field entry, the effective date of the current field entry, and the type of change, which is listed as a “correction.” An exemplary display of a “correction” change details report is provided in FIG. 16A. The system 100 accepts a confirmation from the user to complete the correction in step 1635.

In step 1640, an inquiry is conducted to determine if there is another data change to the same field(s) in the database 105 subsequent to the effective date of the current data change. If there is a subsequent change, the “YES” branch is followed to step 1645, where the historical database 105 propagates and saves the newly entered data field information on an occurrence-by-occurrence basis until one minute before the effective date of the next different information recorded in that data field in the historical database 105. In one exemplary embodiment, an occurrence is a record or something that has a record data, or a change to a record in the historical database 105. The process continues from step 1645 to the END step. Returning to step 1640, if there is not a subsequent change, the “NO” branch is followed to step 1650, where the historical database 105 propagates and saves the new data field information on an occurrence-by-occurrence basis until the present date. The process continues from step 1650 to the END step.

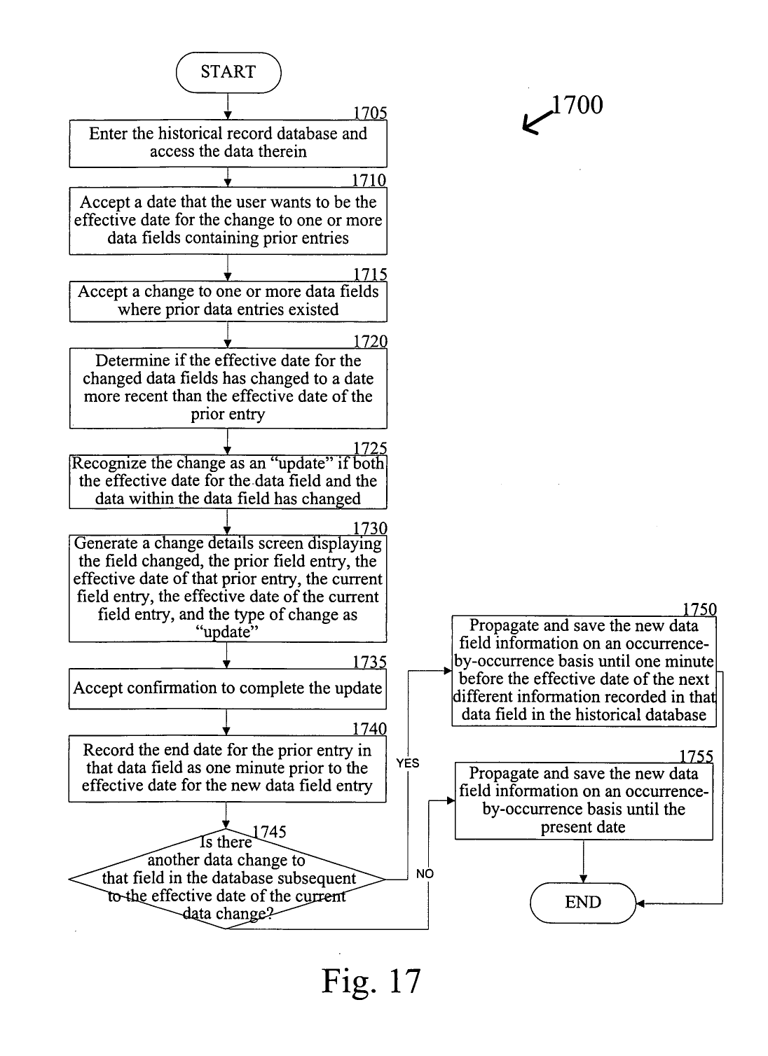

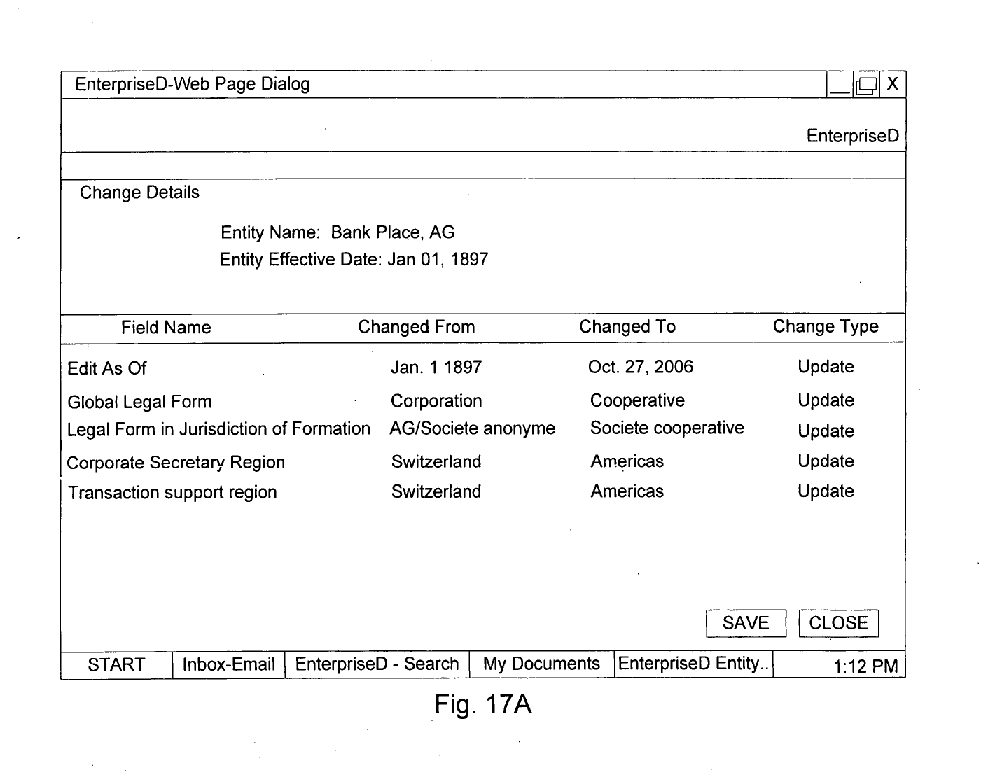

FIG. 17 is a logical flowchart diagram illustrating an exemplary computer-implemented method for completing an update to one or more data fields in the historical database 105 within the operating environment of the current system 100. Referring now to FIG. 17, the exemplary method 1700 begins at the START step and continues to step 1705, where the user enters the historical record database 105 and accesses the data stored therein. In step 1710, the system 100 accepts the date and time that the user wants to be the effective date for the change to one or more data fields that previously contained data therein. As described hereinabove, if the data field did not previously contain data, the system 100 would recognize the insertion of data into that field as a “correction,” no matter what date is selected by the user. In one exemplary embodiment, the user can select a date only and the default time for the initial date will be twelve midnight.

A change to one or more data fields that contained data is accepted by the system 100 from the user in step 1715. The system 100 determines if the effective date was changed to a date more recent than the effective date of the prior entry for the data fields that were changed by the user in step 1720. In step 1725, the system 100 recognizes the change as an “update” if both the effective date for the data field and the data within the data field has changed. In step 1730, the system 100 generates a change details report displaying the fields that were changed. In one exemplary embodiment, the change details report includes, the prior field entry, the effective date of the prior field entry, the current field entry, the effective date of the current field entry, and the type of change, which is listed as an “update.” An exemplary display of an “update” change details report is provided in FIG. 17A. The system 100 accepts a confirmation from the user to complete the “update” in step 1735.

In step 1740, the system 100 records the “end date” for the prior entry in that data field as one minute prior to the effective date for the new data field entry. In step 1745, an inquiry is conducted to determine if there is another data change to the same field(s) in the database 105 subsequent to the effective date of the current data change. If there is a subsequent change, the “YES” branch is followed to step 1750, where the historical database 105 propagates and saves the newly entered data field information on an occurrence-by-occurrence basis until one minute before the effective date of the next different information recorded in that data field in the historical database 105. The process continues from step 1750 to the END step. Returning to step 1745, if there is not a subsequent change, the “NO” branch is followed to step 1755, where the historical database 105 propagates and saves the new data field information on an occurrence-by-occurrence basis until the present date. The process continues from step 1755 to the END step.

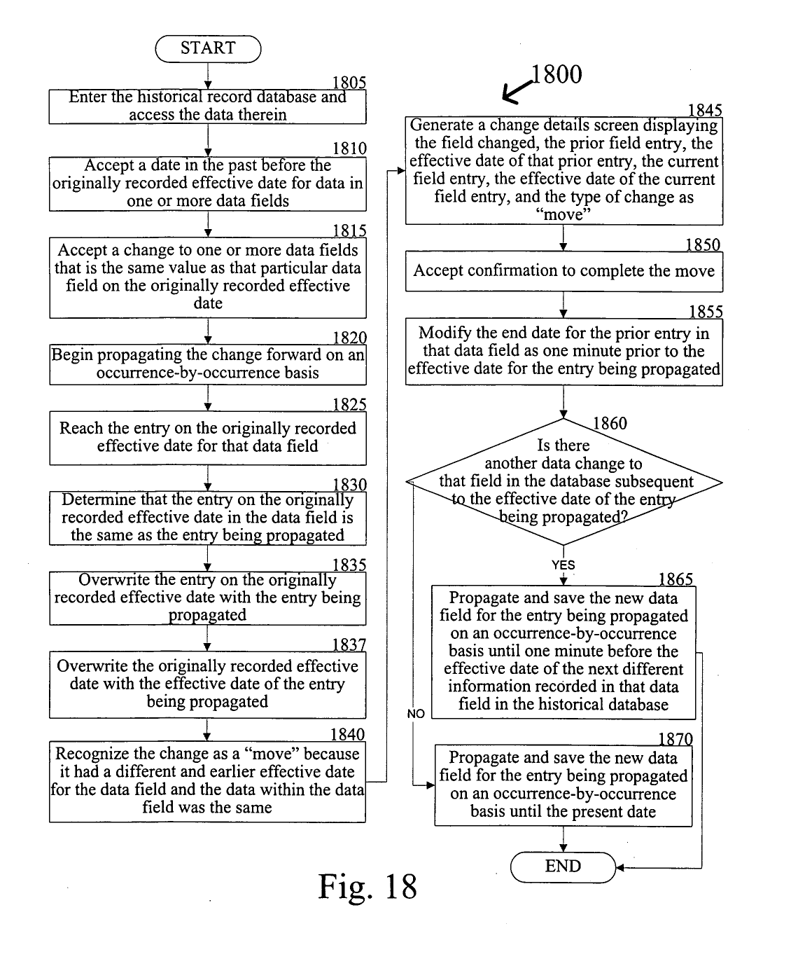

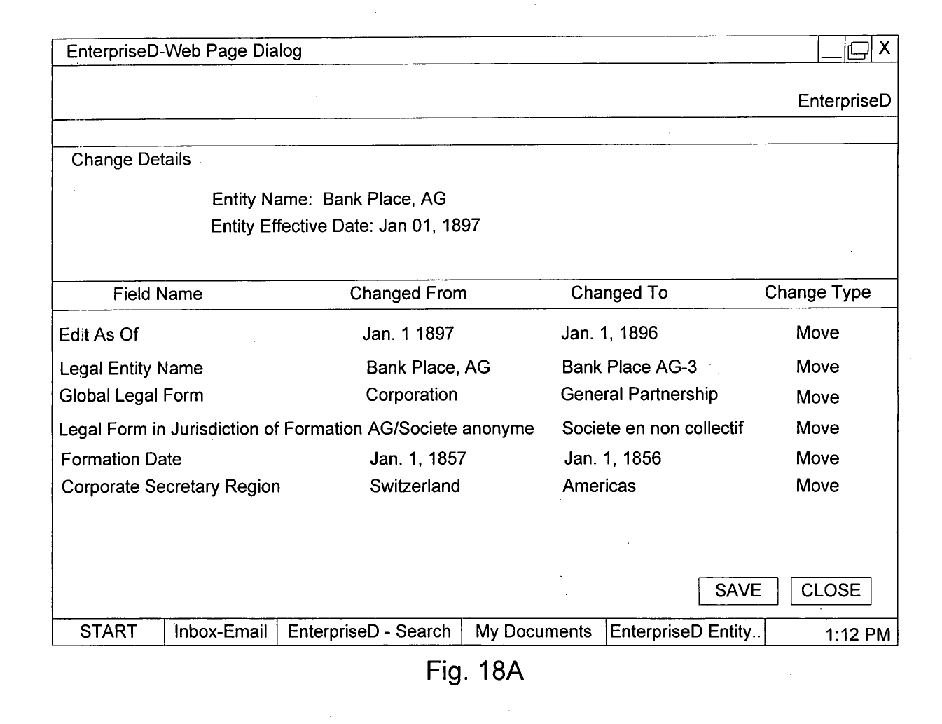

FIG. 18 is a logical flowchart diagram illustrating an exemplary computer-implemented method for moving the edit or insertion date for one or more data fields in the historical database 105 within the operating environment of the current system 100. Referring now to FIG. 18, the exemplary method 1800 begins at the START step and continues to step 1805, where the user enters the historical record database 105 and accesses the data stored therein. In step 1810, the system 100 accepts a date in the past, before the originally recorded effective date, for data in one or more data fields.

The system 100 accepts a change to one or more data fields that is the same value as the particular data field on the originally recorded effective date in step 1815. The system 100 begins propagating the change forward on an occurrence-by-occurrence basis in step 1820. In step 1825, the data entry on the originally recorded effective date for that data field is reached. The system 100 determines that the entry on the originally recorded effective date in the data field is the same as the entry being propagated in step 1830. The system 100 overwrites the entry on the originally recorded effective date with the entry being propagated in step 1835. In step 1837, the system 100 overwrites the originally recorded effective date with the effective date of the entry being propagated. In step 1840, the system 100 recognizes the change as a “move” because the data field had a different and earlier effective date and the data in the data field was the same for both the original entry and the entry being propagated. In step 1845, the system 100 generates a change details report displaying the fields that were changed. In one exemplary embodiment, the change details report includes, the prior field entry, the effective date of the prior field entry, the current field entry, the effective date of the current field entry, and the type of change, which is listed as a “move.” An exemplary display of a “move” change details report is provided in FIG. 18A. The system 100 accepts a confirmation from the user to complete the move in step 1850.

In step 1855, the system 100 records the “end date” for the prior entry in that data field as one minute prior to the effective date for the entry being propagated. In step 1860, an inquiry is conducted to determine if there is another data change to the same data field(s) in the database 105 subsequent to the effective date of the entry being propagated. If there is a subsequent change, the “YES” branch is followed to step 1865, where the historical database 105 propagates and saves the new data field information for the entry being propagated on an occurrence-by-occurrence basis until one minute before the effective date of the next different information recorded in that data field in the historical database 105. The process continues from step 1865 to the END step. Returning to step 1860, if there is not a subsequent change, the “NO” branch is followed to step 1870, where the historical database 105 propagates and saves the new data field information for the entry being propagated on an occurrence-by-occurrence basis until the present date. The process continues from step 1870 to the END step.

While not shown and described in the form of a process flowchart, a user can also modify the effective date to a date subsequent to the date currently in the database 105. To move the effective date forward without modifying the data in the data field, the user would first complete a correction by inserting the immediately previous data record for that field into the field for the original effective date for the data record being modified. The user would then select save and the database will propagate the information forward in substantially the same manner as described hereinabove. Next, the user would complete an update by going to the new, subsequent, effective date and changing the data in the data field to the data for the record being modified. The user would then select save and the database 105 will propagate the information forward in substantially the same manner as described hereinabove.

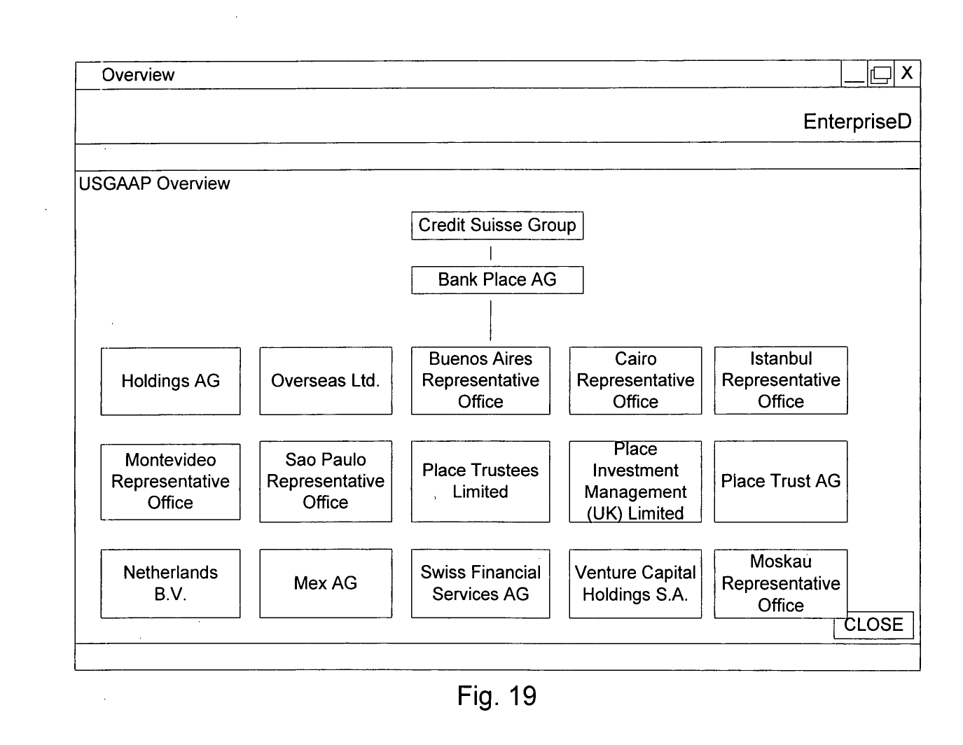

FIG. 19 is an exemplary illustration of a display of consolidated and non-consolidated parents and children of an entity as presented by the system in accordance with one exemplary embodiment of the present invention. In one exemplary embodiment, the system 100 has the capability to display relationships of entities in graphical form, as shown in FIG. 19. A user can supply parent information regarding an entity. In one exemplary embodiment, the system 100 presents one or more data fields for population of data in a financial accounting tab that are populated by the user related to the entity. In this exemplary embodiment, the information provided by the user can include one or more of the following: information to satisfy United States generally accepted accounting principles; information to satisfy Swiss generally accepted accounting principles, and/or information to satisfy International Financial Reporting Standards. An overview link can be presented by the system 100. Once the user selects or activates the overview link, the system 100 evaluates the database 105 or another database to determine the parent entities for a particular entity, The system 100 also can evaluate the database 105 or another database to determine the child entities for the particular entity. The system 100 can further evaluate the database 105 or another database to determine any sibling entities (entities having the same parent entity as the particular entity) for the particular entity. The system 100 then generates a display linking the parent entity to the particular entity and the child entities to the particular entity and displays that on a user interface.

In conclusion, the present invention supports a computer-implemented method for generating the documentation and approvals to form or acquire an entity or initiate a transaction, store entity and transaction data for general corporate, regulatory and financial reporting and monitor changes to the data for the entities and transactions over time at the data field level. It will be appreciated that the present invention fulfills the needs of the prior art described herein and meets the above-stated objectives. While there have been shown and described several exemplary embodiments of the present invention, it will be evident to those of ordinary skill in the art that various modifications and changes may be made thereto without departing from the spirit and the scope of the present invention as set forth herein.

We claim:

1. A computer-implemented method for generating an organizational chart of organizational entities comprising the steps of:
accepting an ownership threshold;
accepting at least one inclusion threshold; wherein the accepted at least one inclusion threshold filters the organizational entities to include in the organizational chart;
determining at least one selected organizational entity comprising the organizational entities that satisfy the organizational threshold and inclusion thresholds;
accepting one of the selected organizational entities;
determining the voting interest of a plurality of parent entities for the selected organizational entity;
designating one of the parent entities as a primary parent entity for the selected organizational entity;
presenting the primary parent entity; and
presenting the parent entities for the selected organizational entity, except for the primary parent entity, separate from the primary parent entity.

2. The method of claim 1, wherein the ownership threshold comprises voting interest in the organizational entity.

3. The method of claim 1, wherein the ownership threshold comprises equity ownership interest in the organizational entity.

4. The method of claim 1, further comprising the steps of:
determining at least one branch entity for the selected organizational entity; and
presenting the at least one branch entity for the selected organizational entity.

5. The method of claim 4, wherein the branch entities are presented below the selected organizational entity.

6. The method of claim 1, further comprising the steps of:
determining at least one entity comprising a representative office of the selected organizational entity; and
presenting the at least one representative office entity for the selected organizational entity.

7. The method of claim 6, wherein the at least one representative office entity are presented below the selected organizational entity.

8. The method of claim 1, further comprising the steps of:
determining at least one child entity for the selected organizational entity; and
presenting the at least one child entity for the selected organizational entity.

9. The method of claim 1, wherein the parent entities for the selected organizational entity, except for the primary parent entity, are presented under the selected organizational entity in order of voting interest in the selected organizational entity.

10. The method of claim 1, wherein the parent entities for the selected organizational entity, except for the primary parent entity, are presented under the selected organizational entity in order of equity ownership interest in the selected organizational entity.

11. The method of claim 1, wherein the primary parent entity comprises the parent entity with the highest aggregate voting interest in the selected organizational entity.

12. The method of claim 11, further comprising the steps of:
determining if more than one of the parent entities has the highest aggregate voting interest;
determining the organizational level of each parent entity having the highest aggregate voting interest; and
designating a parent entity having a highest organizational level from the parent entities having the highest aggregate voting interest as the primary parent entity.

13. The method of claim 1, further comprising the step of accepting additional filtering criteria comprising an include parameter and an exclude parameter, wherein determining at least one selected organizational entity comprises the organizational entities that satisfy the ownership threshold, the at least one inclusion thresholds, and the additional filtering criteria.

14. The method of claim 1, wherein the primary parent entity comprises the parent entity with the highest equity ownership interest in the selected organizational entity.

15. The method of claim 14, further comprising the steps of:
determining if more than one of the parent entities has the highest equity ownership interest;
determining the organizational level of each parent entity having the highest equity ownership interest; and
designating a parent entity having a highest organizational level from the parent entities having the highest equity ownership interest as the primary parent entity.

16. A computer-implemented method for generating a consolidation organizational chart of organizational entities comprising the steps of:
accepting an organizational entity accepting a plurality of filtering parameters for determining if at least one of a plurality of entities is a child entity for the organizational entity;
evaluating a database of entity information to select at least one of a plurality of entities based on the filtering parameters; and
displaying the selected entities as child entities.

17. The method of claim 16, further comprising the steps of:
selecting one of the selected entities;
determining at least one child entity for the selected entity;
displaying the child entities for the selected entity with the selected entity.

18. The method of claim 16, further comprising the steps of:
selecting one of the child entities;
determining if the selected child entity comprises at least one additional parent entity;
displaying the selected child entity with each additional parent entity.

19. The method of claim 16, wherein the plurality of filtering parameters comprises consolidation according to generally accepted accounting principles.

20. The method of claim 16, wherein the plurality of filtering parameters comprises include criteria.

21. The method of claim 16, wherein the selected entities are displayed in alphabetical order.

22. The method of claim 16, further comprising the steps of:
selecting one of the displayed child entities;
determining each additional parent entity for the displayed child entity;
displaying each additional parent entity with the displayed child entity; and
repeating steps (a)-(c) for each displayed child entity.
